(19) United States
(12) Patent Application Publication
(10) Pub. No.: US 2025/0349226 A1
(43) Pub. Date: Nov. 13, 2025

(54) METHOD AND SYSTEM FOR CONVERTING OR ENCODING TEXT

(71) Applicant: Christopher Colin STEPHEN, Broomfield, CO (US)

(72) Inventor: Christopher Colin STEPHEN, Broomfield, CO (US)

(21) Appl. No.: 18/001,509

(22) PCT Filed: Nov. 15, 2022
(86) PCT No.: PCT/AU2022/051361

§ 371 Date: Dec. 12, 2022

(30) Foreign Application Priority Data
Nov. 16, 2021 (AU) 2021903667
Sep. 8, 2022 (AU) 2022228148

(51) Int. Cl. G09B 17/00; G06F 40/117; G06F 40/166; G06F 40/242; G06F 40/284; G06F 40/47; G06F 40/51

(52) U.S. Cl. CPC G09B 17/003; G06F 40/117; G06F 40/166; G06F 40/242; G06F 40/284; G06F 40/47; G06F 40/51

(57) ABSTRACT

A publishing system with components, including:
a system configured to receive at least one document including text that defines a base alphabet in one or more formats;
a system configured to provide additional data for a reader to better understand the document which includes:
   a method of encoding or marking up non-phonetic words in the document to enable the reader to decode sounds of each non-phonetic word; and
a system configured to output an encoded document with the text and the additional data in one or more formats,
wherein the method of automatically encoding the non-phonetic words to make the encoded words phonetic:
   for at least one character (“spelling character”) in the non-phonetic word, using a compound character that includes the spelling character and a sound character, wherein the sound characters:
      are human-readable characters in the base alphabet and/or in one or more secondary alphabets,
      are added to the spelling characters to indicate that each spelling character makes the usual sound of the sound character,
      are added so that spelling characters can be visually discriminated from sound characters,
      are added such that a reader can recognize the non-phonetic word by sight because the spelling of the word is unchanged, and
      are added to the spelling characters such that the spelling characters and the sound characters remain human-readable such that the spelling character and the sound character of each compound character are within one visual field; and
automatically outputting the encoded words in a human-readable form/format such that the compound characters in the encoded word visually indicate which of the spelling characters have a sound other than their usual sound and what sound each character makes in the non-phonetic word when it does not make its usual sound.

### RELATED APPLICATIONS

This application is a national stage application under 35 U.S.C. 371 and claims the benefit of PCT Application No. PCT/AU2022/051361 having an international filing date of Nov. 15, 2022, which designates the United States, and which claims the benefit of Australian Patent Application No. 2022228148, filed Sep. 8, 2022, which claims the benefit of Australian Provisional Patent Application No. 2021903667, filed Nov. 16, 2021, the entireties of which are hereby incorporated by reference herein.

### TECHNICAL FIELD

The present disclosure relates to an integrated and heuristic publishing method and system of converting/encoding words and a text document to a new format or formats that can be optimized for groups or individuals, including to improve text readability/pronounceability, improved auditory discrimination, vocabulary acquisition by a reader and/or comprehension by a reader and can be extended with integrated interactive intelligent systems to optimize the alphabet characters a reader uses, to optimize vocabulary acquisition by a reader, to optimize reading skills and/or reader comprehension in the language being studied, and to efficiently improve verbal communication skills, including auditory discrimination and pronunciation in the language being studied, and the simplicity, completeness and intuitiveness to readers of the mark up system can improve the functioning of the computer running the system and assist the development of new algorithms and user interfaces.

### BACKGROUND

Reading, speaking and hearing a language are fundamentally related activities that can be optimized. A child will learn to hear and speak its first language without instruction because a speech region of the human brain has evolved. There is no such region of the brain for reading, and several parts of the brain must work rapidly and efficiently in a systematic way for reading to occur. Reading required the development of new neural pathways and physically changes the brain.

Understanding written and/or spoken communication requires vocabulary: knowing what words mean. Teaching how words are spelled and what words look like, how they are pronounced, what they sound like, and what they mean all contribute to mastery of the language and mastery of a set of skills, such as being a medical practitioner.

Reading is decoding the sounds of written words and the reader hearing the sounds of the words in their heads using the speech regions of the brain. On hearing the sound, the reader recalls the meaning of the words and then understands the meaning of the text. Therefore, accurately decoding the sound of a written word is a condition precedent to understanding the meaning of the text representing that word.

Cognitive Load Theory (CLT) is an experimentally developed theory focusing on how to efficiently transfer new information from working memory to long term memory.

Speed is important: humans need to hear the words in their heads at about the same rate as spoken language to maximize their comprehension, which is called fluent reading. Fluent reading is required for good comprehension. Read too slowly, and the reader finds it hard to comprehend the text as the reader forgets the words at the beginning of the text. To develop fluent reading and good comprehension, students therefore need to develop sightword recognition-seeing a word and instantly knowing its sound and meaning. An example of sightword recognition is seeing a STOP sign. As soon as someone sees the STOP sign, they hear the word STOP in their mind. Cognitive psychology and cognitive load theory tell us that the fastest way to develop sightword recognition is by sounding out words one phoneme at a time (“phonemes” are sounds, and “characters” are symbols that represent the sounds)—our memories remember things that make sense, but are very poor at remembering random information like the sound of a word and its shape when the word does not sound the way it is spelled. If the word does not sound the way it is spelled, it must be learned by rote. Rote learning requires a lot of repetition. A reader phonetically sounding out a new word 3-5 times may develop sightword recognition, because there is a simple relationship between the sounds and the letters, but 20-50 repetitions may be needed for rote learning of a word which does not sound the way it is spelled because there may be little relationship between the sound of the word and its spelling. Humans have evolved to remember things that make sense, but we have not evolved to remember random information.

An example of a non-phonetic language is English, as more than half the words in English are not pronounced as they are spelled. Examples include: “baked” and “naked” have similar spelling and are pronounced differently, the character “U” has 7 sounds (up, use, put, fruit, busy, quick and bury), and in the word “signature”, the character “g” is pronounced, but not in the word “sign”.

English has 42-45 phonemes (depending on definition) and 26 characters. This means that many English characters must make more than 1 sound, which is confusing for readers.

Erratic English spelling is a huge literacy problem. A study conducted in Europe found Finns learned to read phonetic Finnish in 3-6 months, whereas English language students took 2.5-3 years to reach the same level. A second study of 1200 Italian students found a number of dyslexic students could read Italian (a phonetic language) well enough to progress to university without needing special assistance. Clearly it is much easier to learn to decode a language written phonetically as there are no rules to learn: readers learn a new word by sounding out that word character by character with no rules or exceptions. Readers can therefore be confident in their decoding skills and in their ability to correctly pronounce that word.

English spelling is so erratic that an AI based computer system was unable to accurately decode the sound of many English even though it was trained on over 100,000 English words.

The erratic spelling of English also causes problems with accurate auditory discrimination of English phonemes, syllables and words, and pronunciation problems, resulting in poor spoken communications. Consider the following: a person is in a meeting and hears a foreign language speaker say their name. The person hearing the name does not recognize what was said. But when handed a card with the foreigner's name written on it, the person hearing the name can discriminate the name because that person knows what to listen for.

Similarly, having words marked up phonetically allows people to accurately know how to pronounce a word, and experiments published in peer reviewed academic journals show better pronunciation from written words than just by hearing the words.

People learn by absorbing information by reading and hearing information. It is critically important that people are able to understand what they read and hear. They need to read fluently, at a similar rate to spoken communication. They need good auditory discrimination so that they can accurately recognize individual words. They need to be able to pronounce words accurately enough for people to understand them. They need to know what the words mean to be able to understand what they read or hear. The erratic spelling of English makes it more difficult for people to master reading and spoken communications.

The current methods of teaching how to decode the sound of English words that is used in many countries is a system called synthetic phonics. This system has multiple rules and exceptions. When a student encounters a new word, the student does not know if the word is phonetic and can be sounded out, if a pronunciation rule applies, e.g., “cake” is pronounced /cayk/, or if the word is an exception. (The characters/cat/represent the sound of the word “cat” when pronounced by an English speaker.) There are many exceptions to such pronunciation rules. This can be very confusing to students.

Another method of teaching the decoding of English words that eliminates the rules of synthetic phonics is to mark up words so they can be sounded out phonetically. One system uses glyphs to inform a reader what the sound of a character makes in a particular word (watch), what characters are not pronounced in that word (sign), and where the syllable breaks are in that word (baked and naked). This system works considerably better than synthetic phonics. However, there are problems that became apparent with this approach: the glyphs did not intuitively mean something to the reader, and had to be learned, which took time (sometimes weeks) and created significant barriers to wide spread adoption, not all English words could be marked up using this system, the system is limited to English, and the mark up system was still ambiguous, because syllable stress was not explicitly displayed.

Existing technologies for generating educational texts and running training exercises are very limited, and many language teaching texts and exercises are manually taught, or poorly automated, e.g., often being difficult for a particular learner.

Long and complex sentences can be hard for everyone to understand, and can be especially hard for someone learning a new language that has a different word order in a sentence from the native language of the learner. To understand a complex paragraph, readers may need to first read a sentence or a collection of sentences several times to be able to break the sentences into meaningful groups of words. Then the reader needs to be able to relate the different groups of words together to understand what is written in the text.

The above examples show the complex and interrelated nature of any language learning system. It also demonstrated the need, in any communication system that uses English, for a system that makes all English words phonetic without the student having to learn anything, allowing anybody who knows the sounds of English characters to decode the sound of any word.

It is desired to address or ameliorate one or more disadvantages or limitations associated with the prior art, or to at least provide a useful alternative.

### SUMMARY

Described herein is a publishing system with components, including:
a system configured to receive at least one document including text that defines a base alphabet in one or more formats;
a system configured to provide additional data for a reader to better understand the document which includes:
   a method of encoding or marking up non-phonetic words in the document to enable the reader to decode sounds of each non-phonetic word; and
a system configured to output an encoded document with the text and the additional data in one or more formats,
wherein the method of automatically encoding the non-phonetic words to make the encoded words phonetic:
   for at least one character (“spelling character”) in the non-phonetic word, using a compound character that includes the spelling character and a sound character, wherein the sound characters:
      are human-readable characters in the base alphabet and/or in one or more secondary alphabets,
      are added to the spelling characters to indicate that each spelling character makes the usual sound of the sound character,
      are added so that spelling characters can be visually discriminated from sound characters,
      are added such that a reader can recognize the non-phonetic word by sight because the spelling of the word is unchanged, and
      are added to the spelling characters such that the spelling characters and the sound characters remain human-readable such that the spelling character and the sound character of each compound character are within one visual field; and
automatically outputting the encoded words in a human-readable form/format such that the compound characters in the encoded word visually indicate which of the spelling characters have a sound other than their usual sound and what sound each character makes in the non-phonetic word when it does not make its usual sound.

The system may be configured to automatically encode/mark up an English word into an encoded word, including silent characters, syllable breaks, stress syllables and/or the sound each character makes, based on inputs from a dictionary/database of word-IPA pairs comprising a plurality of words in the base alphabet and the International Phonetic Alphabet (IPA) representations of those words, optionally wherein the encoded/marked-up an encoded words are checked by one or more of:
automatically, in a computing system, determining whether there is an IPA character or IPA characters in the IPA mark up that is not in the dictionary/database of word-IPA pairs;
automatically, in a computing system, determining whether the characters pairs in the the encoded word are all valid character pairs;
automatically, in a computing system, translating the IPA mark up from more than one dictionary and comparing the translations, and if there are differences, editing the words;
automatically, in a computing system, locating and standardizing words marked up with prefixes and suffixes;
automatically, in a computing system, analyzing the marked up words to locate root words to ensure that the mark up of the root word is standard as possible, including changing the mark up of the root word automatically to a predefined mark up and having the change checked automatically by comparing it to similar words;
automatically, in a computing system, comparing the mark up of words with the same root to check that the mark up is consistent for the root;
automatically, in a computing system, checking that a word with one vowel is a one syllable word, and/or checking that the marked up word with multiple vowels that are separated by consonants has the same number of syllables in the mark up as there are vowels;
automatically, in a computing system, if a new syllable is created, flagging the new syllable for manual checking, including flagging new syllables in which all the spelling characters are the same as the sound characters with a lower priority for checking than syllables in which some spelling characters have different sound characters; and
automatically, in a computing system, playing the syllables in the marked up word and automatically comparing the word sound created in this way against a separate audio recording of the unencoded word.

The method of encoding may include adding syllable breaks, including indicating a syllable break by adding a symbol preceding the syllable, including adding the syllable breaks by:
identifying at least one word (“identified word”) in the source text that matches one of a plurality of preselected words in a preselected set of words formed of the base alphabet, wherein the identified words includes at least one stressed syllable and/or at least one unstressed syllable defined in the preselected set, wherein each syllable includes one or more of the spelling characters, and
replacing/adjusting the identified word by adding a dot/square preceding each syllable, wherein the spelling characters of the syllable remain unchanged, and wherein the dot/square for the stressed syllable differs visually from the dot/square for the unstressed syllable.

The method of encoding may include indicating silent characters, including by visually differentiating the silent characters from the spelling characters without changing shapes of the silent characters.

The system may include one or more interactive teaching/practice computing systems that statically display on a screen or dynamically display in a video or other dynamic display system the encoded words, wherein the interactive computing systems are configured to automatically:
receive user inputs from a user of the interactive computing system;
classify the user into one of a plurality of categories based on the user inputs; and
select a phoneme set from a plurality of sets based on the user category using a predefined mapping between user categories and phoneme sets,
wherein the classifying includes:
   the computing system generating measured values of the user's knowledge/performance; and
   the computing system classifying the user into one of the plurality of categories based on the measured values, and
wherein the interactive computing system is configured to automatically:
   present a test text in the base alphabet to the user by displaying the test text visibly or playing the test text audibly, wherein the test text includes: a plurality of words that can be selected by the user using the user interface (“user-selectable words”) including at least one test word and one or more distractor words which are not the test word; and
   measure the values from user selections of the user-selectable words, including measuring how many of the least one test words are user selected, and/or how much time is taken to select the test words.

Described herein is a method of converting/encoding a text document, the method including:
receiving data representing a source text that includes a plurality of human-readable characters in a base alphabet forming a plurality of words;
encoding the source text by:
   for each word in the source text (i.e., in a word-by-word search of a database of word and corresponding marked-up phonetic words) that has one or more characters (“spelling characters”) that are identified as having a sound other than a usual sound for that character, using a replacement word with respective compound characters that each include the spelling character and a sound character, wherein the sound characters: are human-readable characters in the base alphabet and/or in one or more secondary alphabets,
   are added to spelling characters to indicate that the spelling character makes the usual sound of the sound character,
   are displayed so that spelling characters can be discriminated from sound characters, and
   are added to the spelling characters such that the spelling characters and the sound characters remain human-readable such that the spelling character and the sound character of each compound character are within one visual field; and
outputting the encoded text in a human-readable form/format such that the encoded text includes the plurality of words from the source text with the compound characters visually indicating which of the spelling characters have a sound other than a usual sound for that character, and such that the spelling characters in the words in the encoded text are same and in the same order as the characters in the respective words in the source text.

The sound characters may be in a preselected phoneme set that includes:
a plurality of sound characters in a secondary alphabet associated with phonemes in the base alphabet that can be defined/pronounced using characters in the secondary alphabet;
a plurality of sound characters in the base alphabet associated with phonemes in the base alphabet that do not exist in the secondary alphabet; and/or
a plurality of sound characters in the base alphabet associated with phonemes in the International Phonetic Alphabet (IPA) that do not exist in the secondary alphabet.

The adding of the one or more sound characters may include adding a gap/space between the sound characters and the respective spelling characters such that, in the words in the encoded text, the spelling characters are not touching the sound characters or if the sound characters do touch the spelling characters, less than 5% of the line length of the sound character touches the spelling character.

One or more of any lowercase sound characters may be shaped differently from the corresponding uppercase characters, including having a different font and/or positioned differently relative to the spelling character.

The sound characters may have a font size (“sound font size”) based on a font size (“source font size”) of the source text in a ratio of 6:9 (e.g., sound character font size: spelling character font size) and/or wherein the sound characters have a font size of at least 6 point.

The method may include automatically generating a database (“translation database”) of words for encoding the source text word by word.

The method may include providing a user interface of an interactive computing system for a user to manually select marked-up phonetic words for words in the base alphabet.

The method may include:
the computing system receiving user inputs from a user of an interactive computing system and/or from user input at registration;
the computing system classifying the user into one of a plurality of user categories based on the user inputs; and
the computing system selecting an optimal phoneme set whose characters are comprised by spelling and sound characters from the plurality of phoneme sets based on the user category using a predefined mapping between user categories and phoneme sets.

The method may include showing stress in the replacement word with: a closed dot preceding a stressed syllable, and an open dot preceding an unstressed syllable; a dot preceding a stressed syllable, and a square preceding an unstressed syllable; an open dot preceding a stressed syllable, and a closed dot preceding an unstressed syllable; or a square preceding a stressed syllable, and a dot preceding an unstressed syllable.

Described herein is a heuristic publishing/education/word mark up system that can improve the ability of students to develop mastery in reading, reading comprehension, spoken communication, comprehension of spoken communication and acquisition of a vocabulary, which in turn may lead to improved learning outcomes in many other subject areas, and the simplicity, completeness and intuitiveness to readers of the mark up system can improve the functioning of the computer running the system and assist the development of new algorithms and user interfaces. The system is heuristic (i.e., self learning) and may become more efficient as data is collected, analysed and used to improve algorithms and systems, and make predictions, and the system can quickly test these predictions, allowing upgrades to algorithms driving the system to be implemented, further predictions to be made and quickly tested, and so on, which may iteratively improve student learning outcomes.

Central to this publishing/education system is a method of converting/encoding a text document, the method including:
a. receiving data representing a source text that includes a plurality of human-readable characters in a base alphabet forming a plurality of words;
b. encoding the source text by:
   i. for each word in the source text (i.e., in a word-by-word search of a database of words and corresponding marked-up phonetic words words) that has or more characters (“spelling characters”) that are identified as having a sound other than a usual sound (for that character), using a replacement word with respective compound characters that each include the spelling character and a sound character (which can be represented by a superscript), wherein the sound characters:
      1. are human-readable characters in the base alphabet and/or in one or more secondary alphabets (the sounds of whose letters are already known to a reader),
      2. are added to spelling characters to indicate that the spelling character makes the usual sound of the sound character,
      3. are displayed so that it is easy to discriminate spelling characters from sound characters, and
      4. are added to the spelling characters such that the spelling characters and the sound remain human-readable such that the spelling character and the sound character of each compound character are within one visual field; and
c. outputting the encoded text in a human-readable form/format such that the encoded text includes the plurality of words from the source text with the compound characters visually indicating which of the spelling characters have a sound other than a usual sound (for that character) (and such that shapes made by the spelling characters in the words in the encoded text are substantially the same as shapes of the respective words in the source text).

Described herein is a method of converting/encoding a text document, the method including:
a. receiving data representing a source text that includes a plurality of human-readable characters in a base alphabet forming a plurality of words;
b. encoding the source text by:
   i. for each word in the source text (i.e., in a word-by-word search of a database of word and corresponding marked-up phonetic words, which is a data structure that may be referred to as a “translation database” or a “translation dictionary”) that has one or more characters (“spelling characters”) that are identified as having a sound other than a usual sound (for that character), using a replacement word with respective compound characters that each include the spelling character and a sound character (which can be represented by a superscript), wherein the sound characters:
      1. are human-readable characters in the base alphabet and/or in one or more secondary alphabets (the sounds of whose letters are already known to a reader),
      2. are added to spelling characters to indicate that the spelling character makes the usual sound of the sound character,
      3. are displayed to that it is easy to discriminate spelling characters from sound characters, and
      4. are added to the spelling characters such that the spelling characters and the sound remain human-readable such that the spelling character and the sound character of each compound character are within one visual field; and
c. outputting the encoded text in a human-readable form/format such that the encoded text includes the plurality of words from the source text with the compound characters visually indicating which of the spelling characters have a sound other than a usual sound (for that character), and such that shapes made by the spelling characters in the words in the encoded text are substantially the same as shapes of the respective words in the source text.

The preselected phoneme set may include:
a. a plurality of sound characters in a secondary alphabet associated with phonemes in the base alphabet that can be defined/pronounced using characters in the secondary alphabet;
b. a plurality of sound characters in the base alphabet associated with phonemes in the base alphabet that do not exist in the secondary alphabet; and/or
c. a plurality of sound characters in the base alphabet associated with phonemes in the IPA that do not exist in the secondary alphabet.

The method may include indicating a syllable break.

The method may include indicating a syllable break by adding a symbol preceding the syllable.

The method may include indicating silent characters, optionally by visually differentiating the silent characters from the spelling characters without changing shapes of the silent characters.

The method may include indicating silent characters and syllable breaks.

The adding of the one or more size sound characters may include adding a gap/space between the sound characters and the respective spelling characters such that the words in the encoded text are clearly visible and not touching the sound characters.

The method may include indicating a syllable break, wherein the syllable break indicates if a syllable following the syllable break is stressed or unstressed.

One or more of any lowercase sound characters may be shaped differently from the corresponding uppercase characters, including having a different font.

The outputted text may be in human-readable form/format, including in a physical printed book and/or in an electronic book, optionally including printing the physical book and/or storing the electronic book in a non-transient computer-readable medium.

The sound characters may have a font size (“sound font size”) based on a font size (“source font size”) of the source text in a ratio of 6:9 (sound character font size: spelling character font size).

The sound characters may have a font size of at least 6 point.

The name of the compound characters may be/spelling character/says/sound character/and/or/spelling character/rhymes with/sound character/.

The method may include:
a. receiving user inputs from a user of a computing system;
b. the computing system classifying the user into one of a plurality of categories based on the user inputs; and
c. the computing system selecting the phoneme set from the plurality of sets based on the user category using a predefined mapping between user categories and phoneme sets.

The method may include:
a. the computing system generating measured values of the user's knowledge; and
b. the computing system classifying the user into one of the plurality of categories based on the measured values.

The method may include:
a. the computing system presenting a test text in the base alphabet to the user by displaying the test text visibly or playing the test text audibly, wherein the test text includes: a plurality of words that can be selected by the user using the user interface (“user-selectable words”) of the interactive computing system including at least one test word and one or more distractor words (which are not the test word); and
b. the computing system measuring the values from user selections of the user-selectable words, including measuring how many of the least one test words are user selected, and/or how much time is taken to select the test words.

The method may include generating the measured values by analysing user pronunciation using a voice analysis tool.

The method may include generating the measured values by:
a. playing the sounds of different syllables containing phonemes to be learned in the order that enabled other students in the same student category to score more correct answers in learning exercises or tests;
b. playing the sounds in an accent that enables the student to score more correct answers in learning exercises or tests; and/or

When the student can discriminate the syllables and phonemes pronounced in an accent the student finds easier than a native speaker of the base language, transition the student to hearing phonemes and syllables pronounced by a native speaker of the base language.

Generating the measured values may include:
a. playing the sounds of different syllables containing phonemes to be learned in the order that enabled other students in the same student category to score more correct answers in learning exercises or tests;
b. playing the sounds in an accent that the student to score more correct answers in learning exercises or tests; and/or
c. when the student can discriminate the syllables and phonemes pronounced in an accent the student finds easier than a native speaker of the base language, transition the student to hearing phonemes and syllables pronounced by a native speaker of the base language, by first playing the sound of the syllables and phonemes that the student found easier when listening to a person, e.g., with the same native language as the student speaking these syllables and phonemes.

The method may include generating the measured values by:
a. the computing system displaying at least 3 marked up words, 2 of which are wrong; and
b. the computing system measuring how many wrong words the user selects.

The method may include generating measured values by:
a. the computing system playing a multi-syllable word with at least 2 syllables defining at least 2 respective correct syllables;
b. the computing system displaying at least 2 respective blank boxes and a plurality of user-selectable syllables greater than at least 2;
c. the computing system receiving input from the user selecting at least 2 of the user-selectable syllables; and
d. the computing system measuring how many correct syllables are in the user-selected syllables.

The method may include generating measured values by:
a. the computing system playing the sound of a word defining a first plurality of correct characters;
b. the computing system displaying blank boxes equal to the first plurality;
c. the computing system displaying a second plurality of user-selectable characters, wherein the second plurality is greater than the first plurality;
d. the computing system receiving input from the user selecting the user-selectable characters; and
e. the computing system measuring how many correct characters are in the user-selected characters.

The method may include generating measured values by:
a. the computing system playing the sounds of a respective plurality of words with a time of silence between adjacent ones of the played sounds of the words;
b. the computing system reducing the time of silence between the played sounds based on the input from the user;
c. the computing system playing the sounds of the words slowly in a continuous sound (as used in human to human speech) based on input from the user; and
d. the computing system playing the sounds of the words at the speed of normal speech in a continuous sound (as used in human to human speech) based on input from the user.

The computing system can take a word and pass the word to an automated text to speech software module that is configured to produce an audio file containing the sound of the word which can be stored in a database linking the word text to the word sound. A sentence can be played one word at a time by selecting a word, looking up the database for the sound of that word, and playing that word. The sentence as played does not contain intonation and cadence.

The computing system can take a sentence and pass the sentence to an automated text to speech software module that is configured to produce an audio file of the sentence being read aloud with intonation and cadence. The audio file of the sentence can then be passed to an automated speech segmentation system, such as Aligner developed by Dr Stefan Rapp, which can break the continuous speech containing the sounds of the words in the sentence into discrete words and phonemes. Because the intonation and cadence applying to a word can be different in different sentences, a database linking the word to its sound also contains the document identifier, a sentence identifier and a word identifier, which allows the words in a sentence to be played sequentially with cadence and intonation, with a variable gap between the words.

By breaking the audio signal into the sounds of discrete words, and linking the text of the word to its sound in a database, each word in a sentence can be highlighted as its sound is played. This may assist some readers, e.g., those readers who were never read to as children, and may help to improve auditory discrimination be seeing the word and hearing it pronounced. Multiple choice questions can be added to measure the comprehension of the reader.

Playing the sound of a word whilst highlighting the text of the word may be a useful feature in a reading practice tool.

Using the above methodology, a reading practice tool can also play a sentence in phrases whilst highlighting the sentences.

The split concentration principle of Cognitive Load Theory states that information from multiple sources at once can reduce learning because attention is split. Once readers develop some reading competence, attention is not split if the student only reads, or if the student just listens.

By clicking on a phoneme, syllable, word, phrase, phrasal verb, idiom etc., the reading practice tool could also play individual words, syllable, phonemes, phrases, phrasal verbs (to come up with means to think of) and idioms with or without intonation and cadence.

Similarly, the reader could click a word, phrase, phrasal verb, idiom etc and be presented with the definition or translation of words, phrases, phrasal verbs, idioms etc.

The user inputs may include user-selected values, and the method includes receiving the user-selected values by:
a. the computing system presenting text input prompts and/or selectable lists to the user; and
b. the computing system receiving the user-selected values as inputs in the text input prompts and/or selectable lists,
   wherein the method includes the computing system classifying the user into one of the plurality of categories based on the user-selected values.

The text input prompts and/or the selectable lists may define a plurality of user-selectable values defining: age, sex, native language, education level, and/or English or other language skill level.

The method may include the computing system authenticating and identifying the user by connecting to a learning management system in which the user has a user account.

The method may include the computing system authenticating and identifying the user by connecting to a learning management system in which the user has a user account through an application programming interface (API) of the LMS.

The method may include sending the user category and/or the measured values to the LMS associated with the user account for storage with a user record in the LMS.

The method may include the computing system classifying the user into one of the plurality of categories using a trained classifier, trained on data from users in each of the plurality of the user category groups.

The method may include:
a. the computing system dividing a word from the source text into a plurality of individual phonemes/partial syllables/syllables, including the first character/letter and progressively more characters/letters/digraphs (two letters representing a different sound, e.g. the digraph “ph” represents the sound/f/), incrementing by one phoneme (character or digraph other than a silent character) for each partial syllable/syllable;
b. the computing system sounding out (playing) the partial syllables/syllables of the phoneme progressively in order of length from the user interface of the computing system for the user to hear;
c. the computing system instructing the user to repeat the partial syllables/syllables via the user interface;
d. the computing system recording the user speaking the syllables/partial syllables; and
e. the computing system sounding out the set of the partial syllables/syllables and then the set of the user's recorded partial syllables/syllables, optionally including repeating the sounding out step two or more times.

The method may include the computing system displaying characters, syllables and words on the user interface and simultaneously sounding out (playing) the sound files containing the phonemes, syllables and words.

The method may include:
a. the computing system playing a test sound for a/the user to hear;
b. the computing system displaying a plurality of characters including a test character or characters representing the test sounds in the language; and
c. the computing system measuring whether the user clicks on the test character or characters.

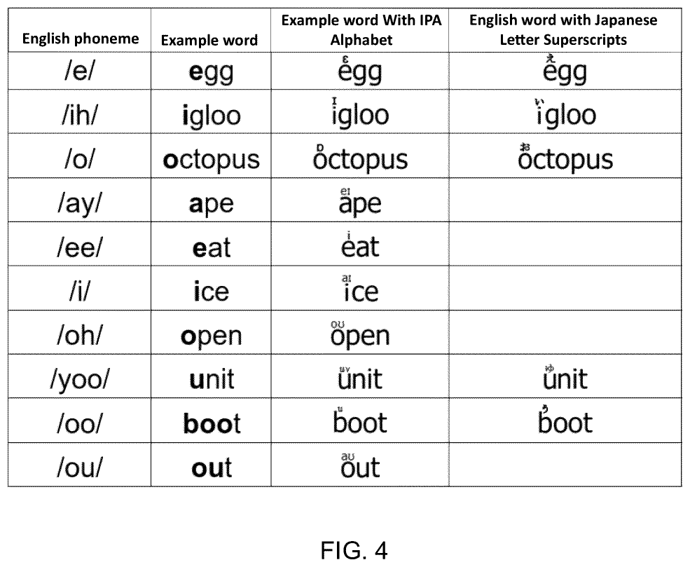

The method may include: the computing system selecting phonemes that are in the base alphabet but not the secondary alphabet based on data representing a predefined phoneme chart (e.g., the Japanese phoneme chart in FIG. 4) including phonemes of the base alphabet and phonemes of the secondary alphabet connected/linked by a corresponding IPA symbol

The method may include:
a. the computing system recording the user pronouncing a test character (and/or phoneme/syllable/word); and
b. the computing system repeatedly playing the user's recording for the user to hear;
c. the computing system repeatedly playing a prerecorded pronunciation of the test character (and/or phoneme/syllable/word) after the user's recording such that the user can hear a difference between the user's recording and the prerecorded pronunciation.

The method may include identifying syllables in the source text, and adding spaces/syllable breaks between adjacent syllables in the encoded text.

The method may include encoding the source text by:
a. identifying at least one word (“identified word”) in the source text that matches one of a plurality of preselected words in a preselected set of words formed of the base alphabet, wherein the identified words includes at least one stressed syllable and/or at least one unstressed syllable defined in the preselected set, wherein each syllable includes one or more of the spelling characters, and
b. replacing/adjusting the identified word by adding a dot/square preceding each syllable, wherein the spelling characters of the syllable remain unchanged, and wherein the dot/square for the stressed syllable differs visually from the dot/square for the unstressed syllable.

The method may include:
a. receiving user inputs from a user of a computing system;
b. the computing system classifying the user into one of a plurality of categories based on the user inputs; and
c. the computing system selecting phoneme set from the plurality of sets based on the user category using a predefined mapping between user categories and phoneme sets.

Described herein is a method (of automatically generating a database of words with compound characters, each including a sound character) including:
a. receiving each word written in English (“English word”) and written in the international phonetic alphabet (“IPA word”);
b. comparing characters (“English characters”) in the English word to characters in the IPA word to identify whether one or more characters have a sound other than a usual sound (for that one or more characters), and if so
c. using a compound character instead of the English character to automatically generate a word (“marked-up phonetic word”) that includes the spelling character and a sound character, wherein the sound characters:
   i. are human-readable characters in the base alphabet and/or in one or more secondary alphabets,
   ii. have a selected secondary font/character size smaller than a base font/character size selected for the spelling character in each compound character, and
   iii. are added to the compound characters such that the spelling characters remain human-readable such that the spelling character and the sound character of each compound character are within one visual field; and
d. outputting a database (“translation database”) of English words and marked-up phonetic words such that shapes of the marked-up phonetic words are substantially the same as shapes of the respective English words.

The same process can be used to mark up words in languages other than English for which there is an IPA marked up word, wherein the method received each word written in the other language, compares characters in the other language, and outputs a database (“translation database”) of words in the other language.

The method may include providing a user interface for a user to manually select marked-up phonetic words for the English words.

Described herein is a method of encoding a word to make the encoded word phonetic and intuitive to the reader by encoding the word by:
a. using respective compound characters that each include the spelling character and a sound character (which can be represented by a superscript), wherein the sound characters:
   i. are human-readable characters in the base alphabet and/or in one or more secondary alphabets,
   ii. are added to spelling characters to indicate that the spelling character makes the usual sound of the sound character,
   iii. are displayed so that it is easy to discriminate spelling characters from sound characters,
   iv. are added such that it is easy for a skilled reader to recognize the word by sight (sightword read the word), and
   v. are added to the spelling characters such that the spelling characters and the sound characters remain human-readable such that the spelling character and the sound character of each compound character are within one visual field; and
b. outputting the encoded word in a human-readable form/format such that the compound characters in the encoded word visually indicate which of the spelling characters have a sound other than a usual sound (for that character).

The method may include adding characters and/or symbols to represent sounds that are not unambiguously specified by characters in the base alphabet.

The method may include adding syllable breaks, wherein the syllable breaks explicitly and unambiguously inform the reader whether the syllable is stressed or unstressed and/or adding a symbol to explicitly and unambiguously inform the reader whether a phoneme or digraph is voiced.

The syllable breaks may be added in a way to minimize the number of syllables.

The shape of the word as spelled by the spelling characters may be substantially preserved.

The sound characters may be easily visible so that a reader can quickly and efficiently sound out a new word, and at the same time, the sound characters may be displayed so that they do not interfere with the efficiency of reading by a reader skilling in reading words as spelled using the spelling characters.

A word may be fully or partially marked up using the mark up in the IPA of that word.

Described herein is a method including:
a. receiving data representing a source text that includes a plurality of human-readable characters in a base alphabet forming a plurality of words;
b. encoding the source text by:
   i. for each word in the source text (i.e., in a word-by-word search of a database of words and corresponding marked-up phonetic words words) that has or more pieces of explicit information about the decoding the sound of that word; and
   ii. outputting the encoded text in a human-readable form/format such that the encoded text includes the plurality of words from the source text with the explicit information about decoding the sound of that word.

Described herein is non-volatile computer-readable storage including machine-readable instructions configured to cause a computing system to perform of any one of the above methods when the machine-readable instructions are executed/performed by one or more microprocessors of the computing system.

### BRIEF DESCRIPTION OF THE DRAWINGS

Some embodiments of the present invention are hereinafter described, by way of non-limiting example only, with reference to the accompanying drawing, in which:

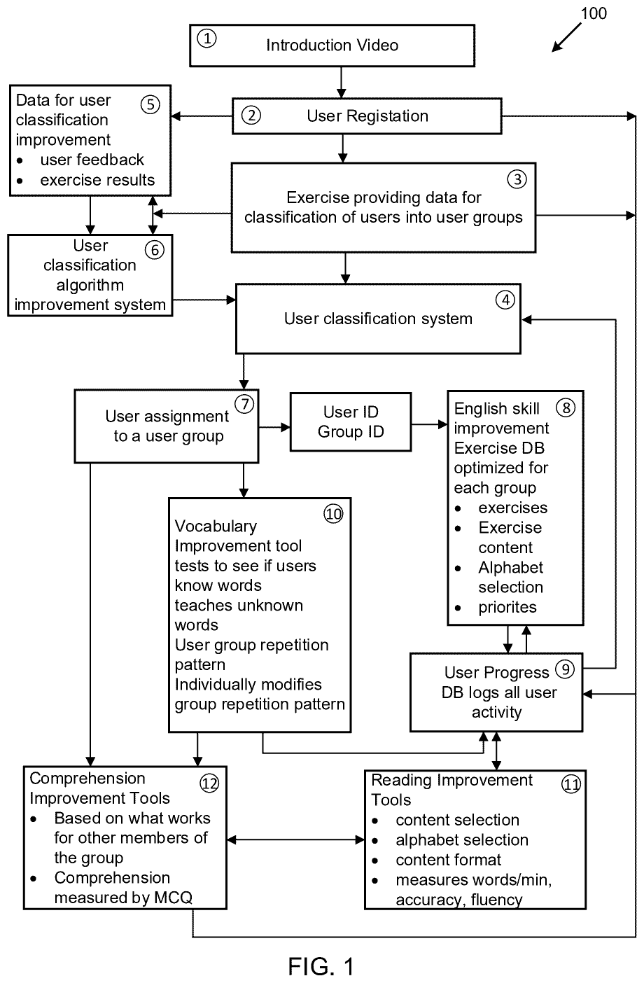

a. FIG. 1 is a chart of a method for learning described herein;

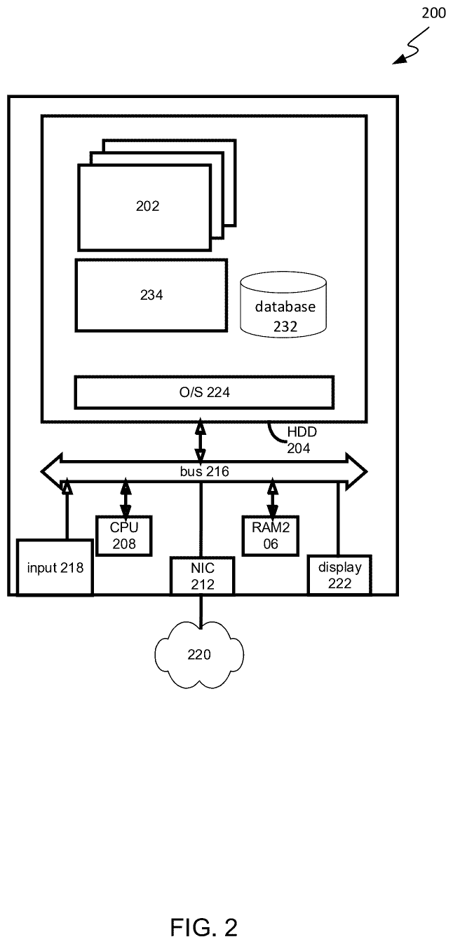

b. FIG. 2 is a block diagram of a computing system configured to perform the method;

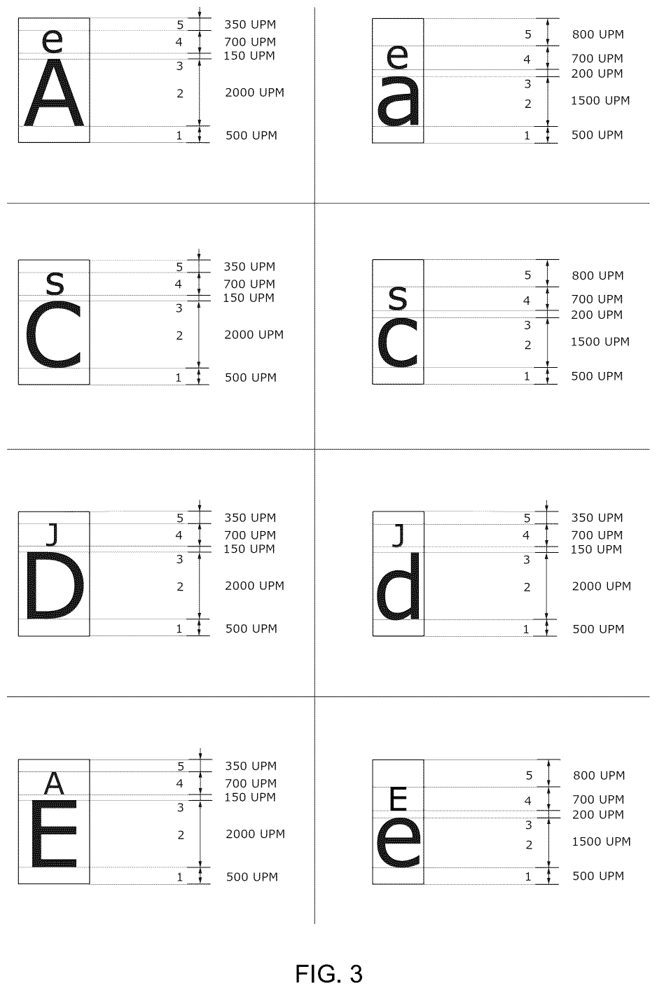

c. FIG. 3 are diagrams of compound characters used in the method;

d. FIG. 4 is a chart of English phonemes and corresponding marked-up phonetic words (including the compound characters) with IPA and Japanese superscripts;

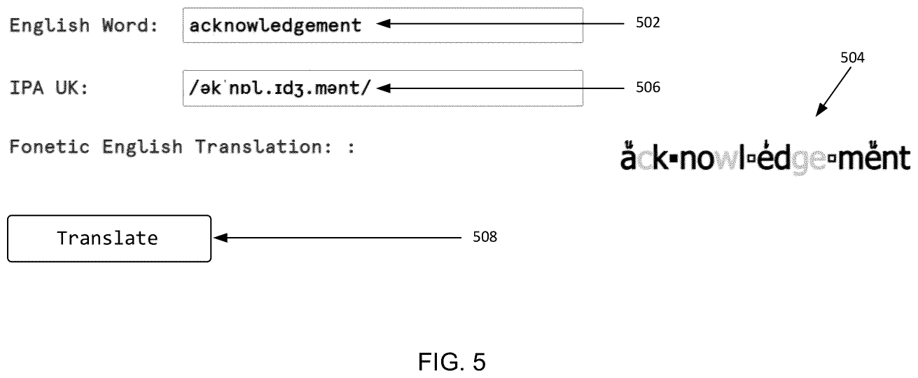

e. FIG. 5 is a screenshot of a program that can take an English word and the translation of that word into the IPS and automatically produce a marked up version of the English word in “Fonetic English” using the compound characters;

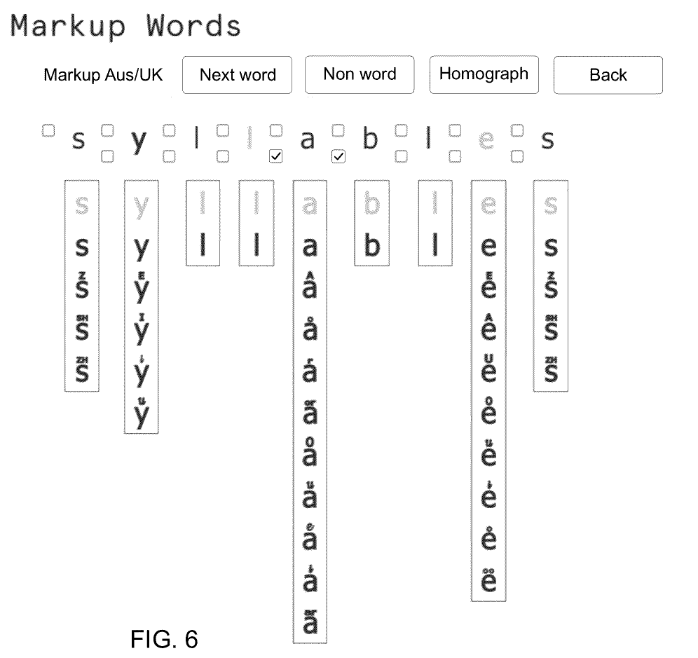

f. FIG. 6 is a screenshot of a user interface (UI) for selecting compound characters to replace original characters in an English word to form a marked-up phonetic word for a database (“translation database”) of English words linked to corresponding marked-up phonetic words;

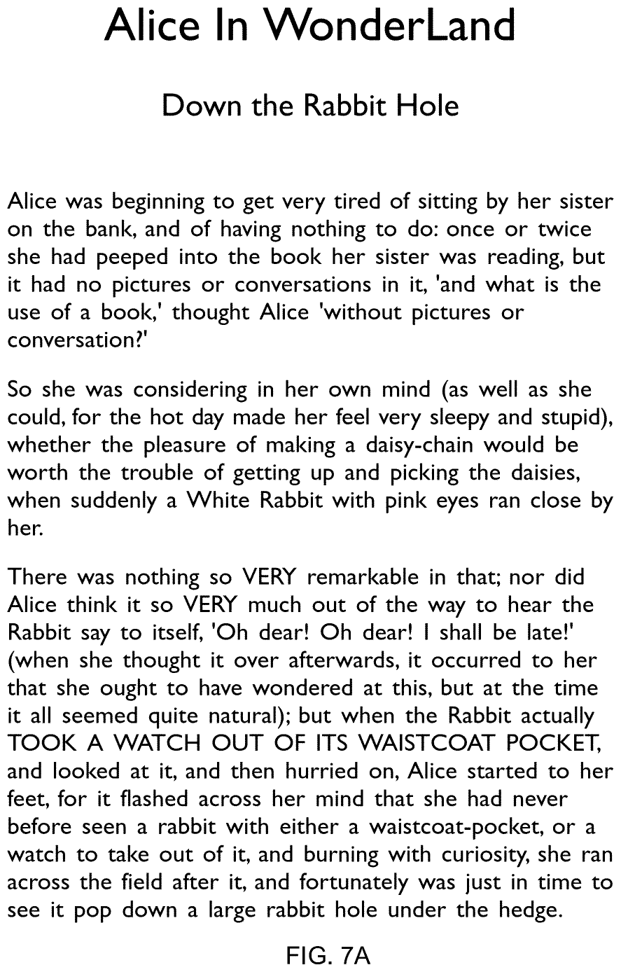

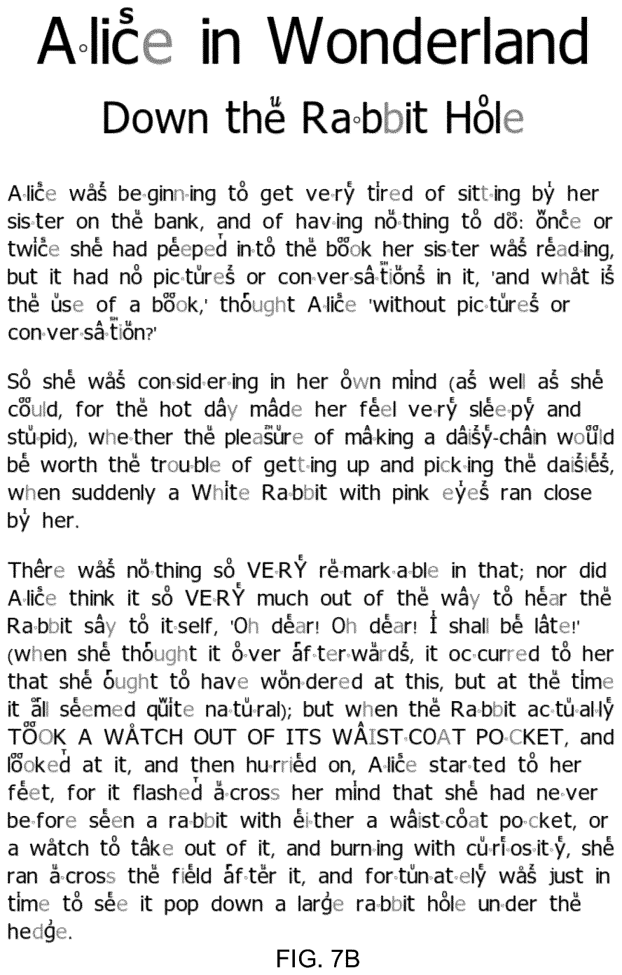

g. FIG. 7A is an example of 3 paragraphs of a book;

h. FIG. 7B is an example of encoded text using the compound characters, with the text of 7A encoded into Fonetic English;

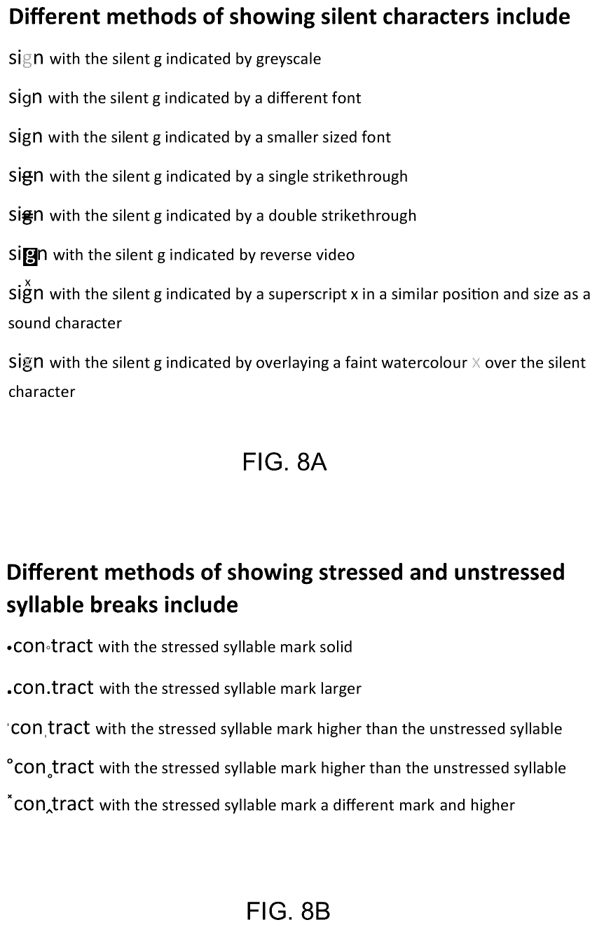

i. FIG. 8A is a list of English examples of displayed silent characters;

j. FIG. 8B is a list of English examples of displayed stressed/unstressed syllable breaks;

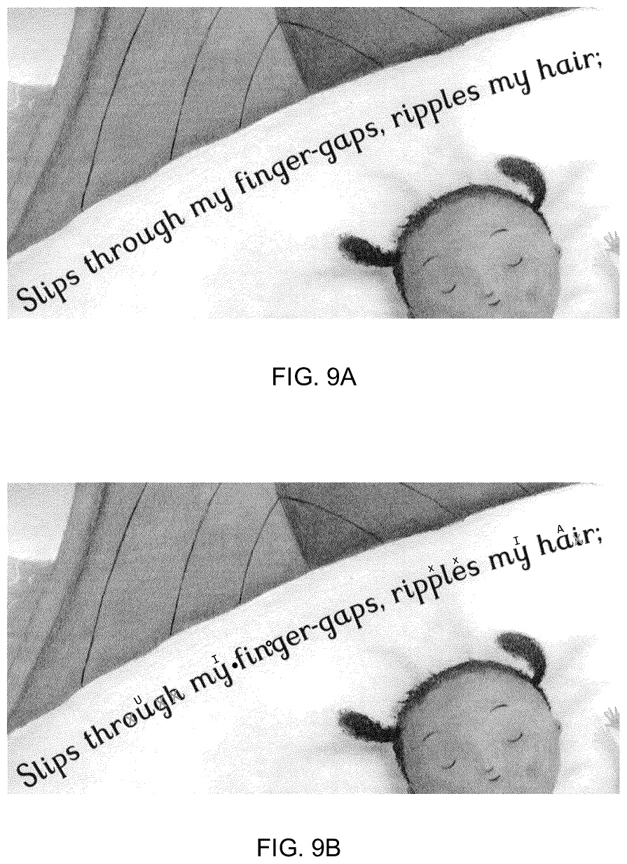

k. FIG. 9A is an example text in English in a non-standard font;

l. FIG. 9B is encoded text in the non-standard font, encoded in Fonetic English, corresponding to the text in FIG. 9A;

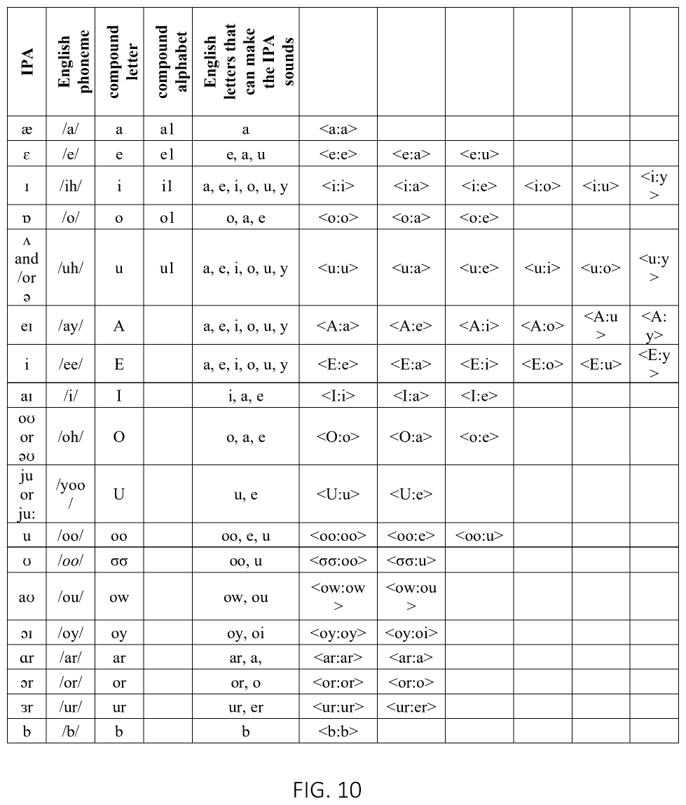

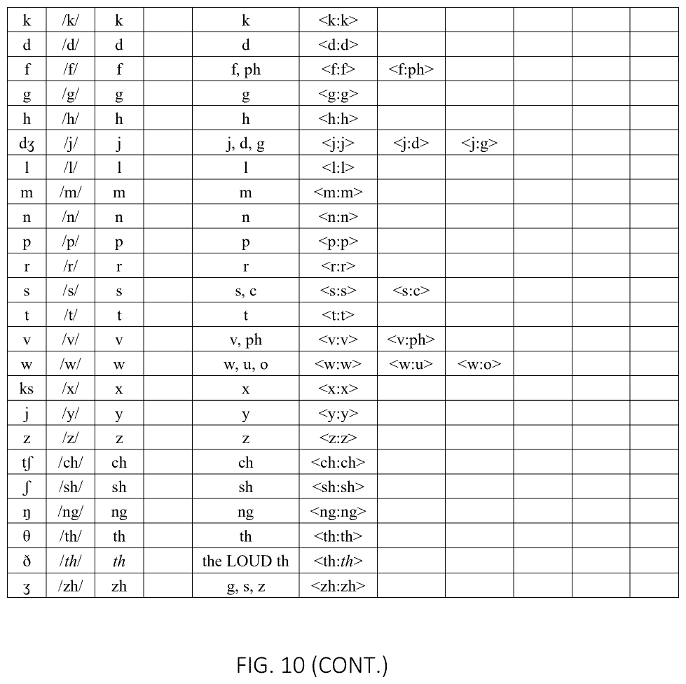

m. FIG. 10 is an example IPA to compound-word translation table;

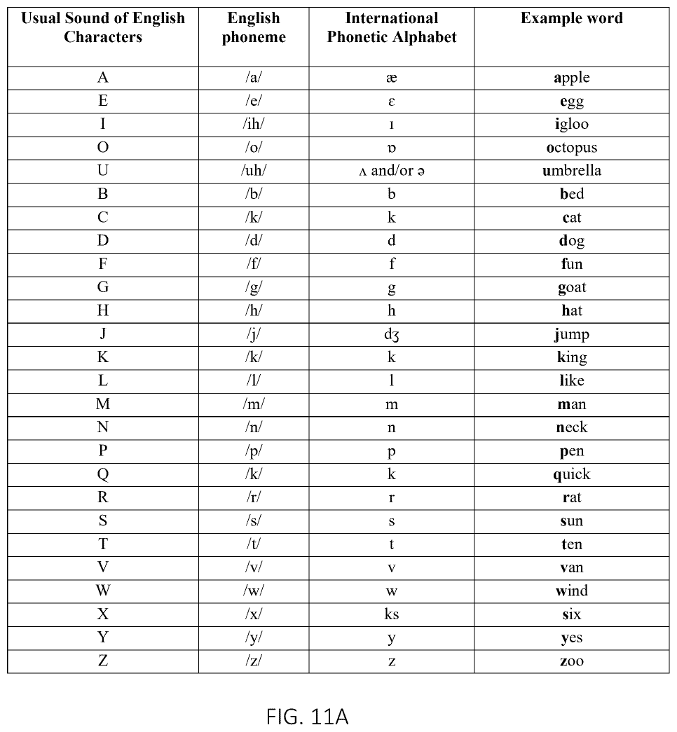

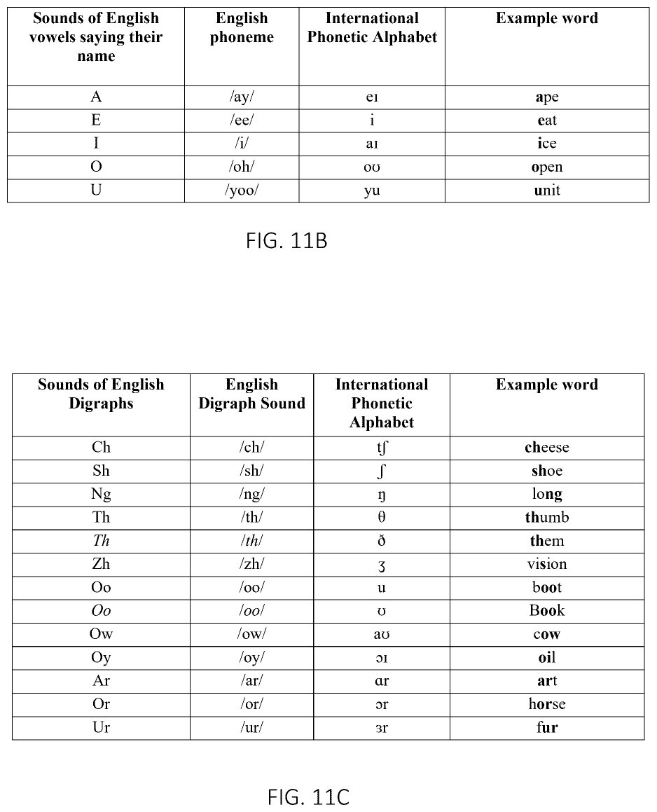

n. FIG. 11A is a table showing usual sounds of English characters;

o. FIG. 11B is a table showing sounds of English vowels saying their name;

p. FIG. 11C is a table showing usual sounds of English digraphs;

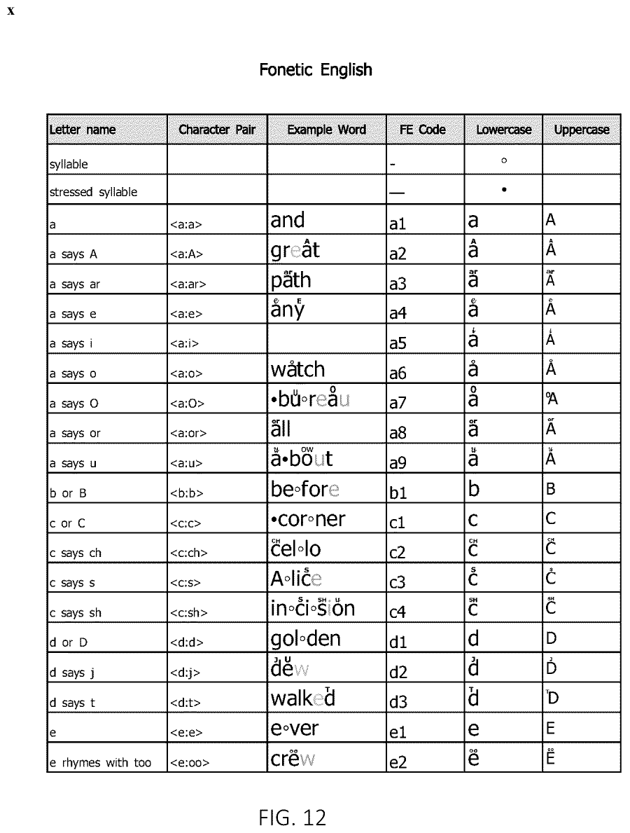

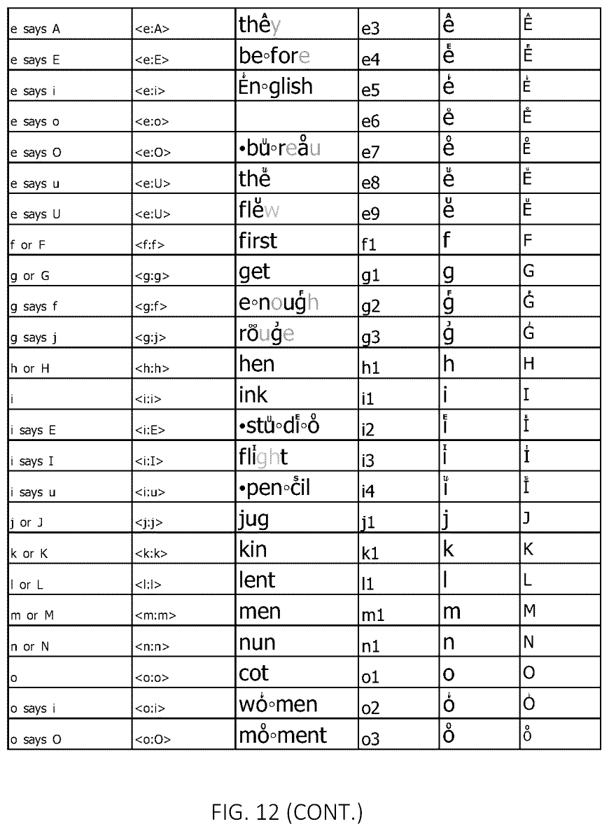

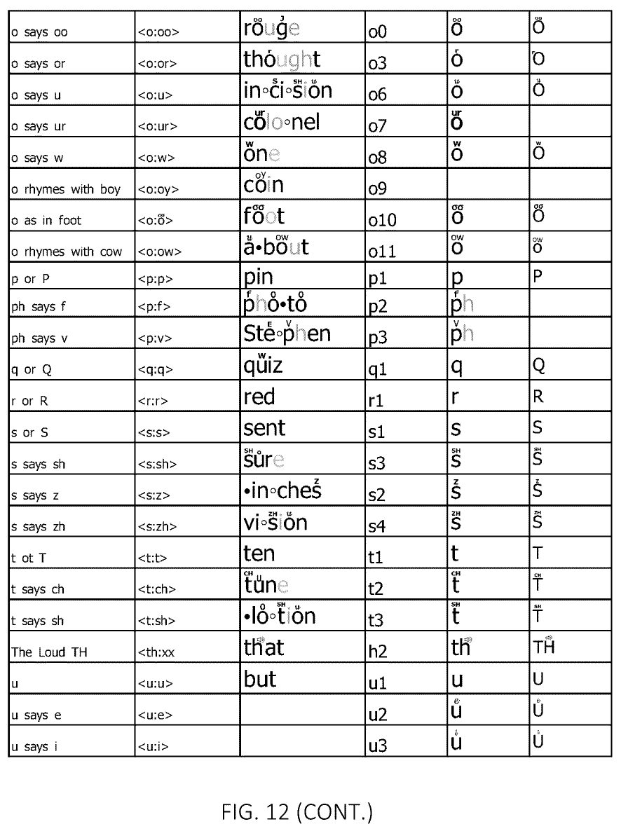

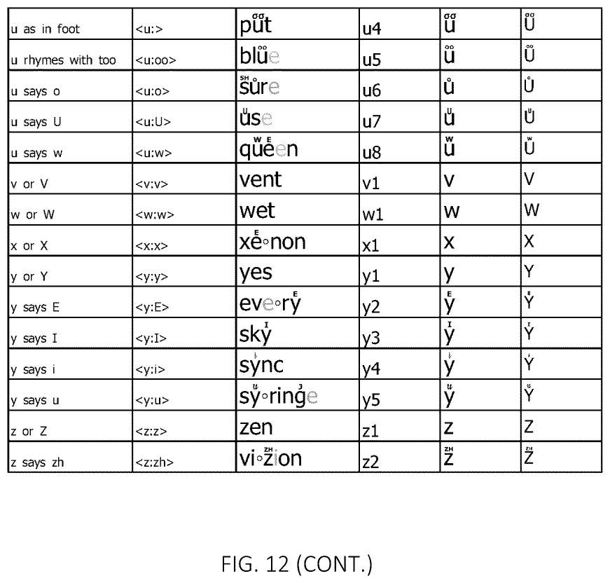

q. FIG. 12 is a table of the fonetic English alphabet; and

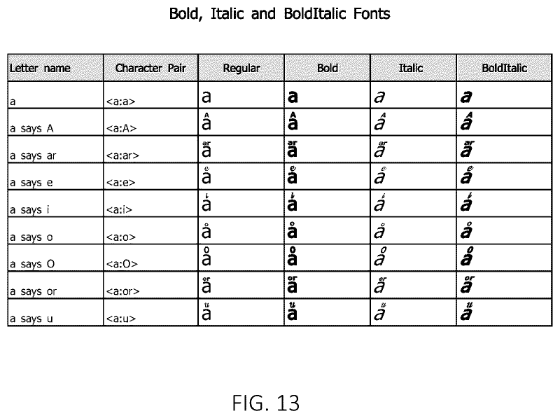

r. FIG. 13 is a table showing some bold, italic and bold italic fonetic English characters in fonetic English alphabet.

### DETAILED DESCRIPTION

### Overview

The publishing system described herein applies the rules of Cognitive Load Theory described briefly herein with the goal of providing a reader to quickly access all the information required to understand a document and learn from it as efficiently as possible. Different readers have different information requirements. For example, one reader may be able to read a word by sight, and another reader may need to decode the sound of that word to learn it. If the word is non-phonetic, the reader cannot easily decode that word by sounding out each character in turn. It is important not to overwhelm a reader with too much information when displaying the information, so, on a digital screen, providing readers with display choice is important. With print on demand technology, cost effective individualization is possible for print books. Readers can be categorized into different groups with similar information needs. This enables the publishing system to experimentally optimize the learning outcomes for members of the group in the following processes: (i) the information requirements of a group of users by trialling different information mixes, measuring the results, analysing the measurements to predict a better learning outcome, implementing the predicted improved information mix and repeating the cycle; and (ii) a similar process can be used to optimize the interface for a group of users. Such testing of readers (i) may provide more accurate categorization of users into groups, (ii) may indicate a specific problem that the reader has, and if a teaching tool is provided to help that reader overcome their problem, the reader may be better able to better comprehend what they read and enjoy better learning outcomes. The optimization of the information mix and the way this information is displayed to a user can be individualized for that user to improve learning outcomes. The information used for individual optimization includes: (i) Native language of the user and the language which they want to read (target language), (ii) Age and educational attainment of the user, and (iii) Knowledge of the target language including vocabulary or predicted vocabulary. As a result of this understanding, the publishing system that uses the “Fonetic English” outputs described hereinafter incorporates systems that have been designed to help readers develop their language, reading and comprehension skills while they are reading to learn. These systems are not limited to just the English language or the Roman alphabet. The publishing system relies on number of new, tightly integrated computer algorithms/processes described herein that are built around, and are only possible because of, the mark up system described herein. The reasons for this include: (i) The mark up system provides complete pronunciation instructions for each word: the sound each character makes (including no sound), the syllables are indicated, and stressed syllables are marked. (ii) Every word in the target language is made up of phonemes of that language so that every word in that language can be marked up in the mark up format. (iii) The spelling of each marked up word is unchanged.

The system is heuristic (self learning) and may become more efficient as data is collected, analysed and used to improve algorithms and systems, and make predictions, and the system can quickly test these predictions, allowing upgrades to algorithms driving the system to be implemented, further predictions made and tested, and so on, which may iteratively improve student learning outcomes.

The elements of a publishing system applying the rules of Cognitive Load Theory include:
a. a system to receive documents in a variety of formats, which may include a system configured to receive (e.g., file transfer server and a digital file storage system):
   i. a text file,
   ii. a text file with formatting, such as a Word file, an HTML file and/or a PDF file,
   iii. a file where the text is marked up into XML or in some other way,
   iv. a scanned image of text which is then decoded with a scanner with optical character recognition to convert the scanned image into a text file with or without format mark up, and/or
   v. a text file produced from a spoken sounds via voice recognition software;
b. a system to provide additional data for the reader to better understand the document which includes:
   i. marking up the non-phonetic words to enable a reader to quickly, easily and accurately decode the sounds of each word,
   ii. linking words to their definitions and/or their translations. To maximize utility, the definition should reflect how the word is used in that document, not just a link to a dictionary definition with multiple possible meanings,
   iii. highlighting idioms and phrasal verbs (“to come up with”=“to think of”) and linking to their definitions,
   iv. linking syllables, words and phrases to their pronunciation in multiple different accents to allow the reader to choose their accent of choice,
   v. playing text to a reader in their accent of choice, at their speed of choice, with or without breaks between the words, with or without intonation and/or cadence, having the word highlighted as pronounced and so on, and/or
   vi. breaking sentences into phrases;
c. a system to output the information in one or multiple formats, which may include:
   i. a print driver to print from a local printer, and the printer itself,
   ii. a formatter to format a file as a book for print on demand (POD) or for a print run (which may require different formats),
   iii. storage for the information formatted as a book for a POD facility or a print shop for production of a physical book,
   iv. a display for displaying an HTML document on a screen,
   v. a file with a PDF document in a format preferred by the reader (e.g., font size, embedded links to other document if the document is view electronically etc.), and/or
   vi. non volatile memory with the document stored in the non volatile memory, including on local media and/or remote file storage; and
d. a system to optimize reading and learning outcomes by:
   i. categorizing users into groups,
   ii. optimizing the information mix and display for each user group, and/or
   iii. recording the usage of a particular user, testing that user, categorizing the user into a group, and using the group and the individual's usage and test data, predict an optimal format which can be interactively optimized as described above.

This system can be extended to individualize formats for a particular user

Practice and learning tools, enabled by the isomorphic relationships between compound characters (spelling characters with sound characters) plus the ability of “Fonetic Alphabets” described herein to mark up every word, have been developed that are built incorporating the word mark up to help readers of documents produced by the publishing system to improve their reading, comprehension and spoken language skills. These tools are described below and include tools to help readers quickly to:
a. select a version of the mark up best suited to their current situation. For example, a reader may select a mark up of English spelling words with English, IPA and letters from their native alphabet;
b. decode new words;
c. develop sightword recognition for new words;
d. learn vocabulary;
e. improve auditory discrimination and pronunciation; and/or
f. other applications are described herein.

To be successful, a word mark up system may need to:
a. be intuitive to readers so learning is absolutely minimized and thus efficient;
b. be comprehensive so that all English words can be marked up; and/or
c. explicitly and unambiguously display everything a reader needs to know to accurately decode the sound of a written word, requiring that:
   i. all English phonemes are explicitly and uniquely represented in the mark up,
   ii. all stressed syllables are explicitly marked, (this may be important because a word like “contract” has different meanings if the first or the second syllable is stressed) and/or
   iii. voiced letters and digraphs are marked (for example, the digraph “th” can be voiced, meaning that the larynx is engaged as in the word “the” but the “th” digraph is not engaged in the word “with”; a speaker icon can be used to indicate voiced letters or digraphs).

The ability to explicitly, precisely and unambiguously define sound that a word makes, the ability to explicitly, precisely and unambiguously mark up all words in a language, and the ability to explicitly, precisely and unambiguously represent the sound of a character in a word even it makes a sound other than its usual sound, and without changing the spelling, together make possible a heuristic computer system and architecture that may enable documents to be optimized for groups of readers, and for individual readers, to increase comprehension of the documents, as well as being able to assist some readers to overcome issues that limit their comprehension, is herein described below. The heuristic ability of the system and the algorithms driving the system may iteratively improve learning systems.

To overcome the pre-existing word mark up system problems, and to make a phonetic word mark up system intuitive, instead of assigning new symbols which need to be learned to inform a reader what sound a character makes in a particular word, instead symbols are used in this disclosure that represent a specific sound that is known to the reader. Symbols with a known sound are characters in an alphabet that is known to the reader. The characters in the word as it is spelled are called the spelling characters, and the added symbols informing the reader of what sound that character actually makes in the word is called the sound character. In the example of English, sound characters could include:
a. English characters (if the reader is a native English speaker or knows the sound of English characters),
b. IPA characters if the reader knows the IPA, and/or
c. characters from the native language of the reader if each character makes the same sound as an English phoneme.

In some languages, some phonemes do not have unique characters that represent a phoneme, or a way the phoneme is pronounced is not explicitly shown. Additional information must be introduced to explicitly, unambiguously and precisely specify this information so that the sound of all words can be explicitly, unambiguously and precisely specified.

In English, for example, the digraph “00” can make two sounds as in the word “too” and the word “foot”. Two Greek letter lowercase sigma characters “00” are used to represent the sound of “00” as in “foot”. Another issue is that the digraph “th” makes a different sound in the word “with” (the “th” is unvoiced) and the word “that” (the digraph is voiced). The voiced digraph is represented by a speaker symbol.

One application of the new phonetic format is for readers to quickly and efficiently learn the sounds of new words whilst they are reading, e.g., an academic text or a technical document. It may be important that readers can:
a. quickly and conveniently read words they know by sight so the shape of the original words are preserved, and the sound characters are formatted so that they do not distract a reader when reading; and
b. be able to efficiently decode the sound of new words, so when the reader wants to decode the sound of a new word, the sound characters are clearly visible and explicitly inform the reader the sound that each character makes in that word.

Animals need to instantly see and recognize dangerous animals so they can escape or defend themselves. Humans are very good at seeing snakes even when the snakes are hiding. When a human sees a snake, the reaction is instant. Scientists call this the Snake Detection Theory. Reading likely uses the skill to detect snakes. Readers recognize the shape of the word and have the word shape, sound and meaning almost instantaneously recalled from long term memory. And it doesn't matter how the word is written—it can be printed normally, can be in a curly type, can be printed badly or the letters can be handwritten, and we can still recognize it by its shape. Being able to recognize disguised words is how readers can prove to some websites that they are humans, not computers. Provided the word shape is preserved, readers are able to recognize the shape of a word even if mark up is added to the word, so readers can read marked up words by sight.

Breaking words into syllables means that the sound and meaning of syllables can be taught independently. Some 13,802 words can be made from the most frequently used 500 syllables. In medicine, the term “ectomy” means removal of something. For example, a tonsillectomy is the removal of the tonsils, and an appendectomy is removal of the appendix. In a similar way to the way the sounds of words can be simply decoded from the sounds of syllables, the meaning of a word can often be decoded from the meaning of the components of a word. This is called morphology. The central part of a word is called the root. It is important to clearly visually discriminate the prefixes and suffixes of a word, and be able to clearly identify the root of a word. Prefixes and suffixes are added to the root to give additional meaning. In addition, the meaning of the prefixes, suffixes and root word must be known for the student to understand the compound word made up of prefixes and suffixes appended to the root word.

Recall vs recognition: recognition of a word is easier to achieve than recall of the word. Recognition is required for reading-you recognize the word when you see it; recall is required for speaking and/or writing when there is no memory cue. Reading practice improves recall.

Some medical practitioners and medical academics consider the acquisition of a medical vocabulary one of the most time-consuming tasks in becoming a doctor. Many medical terms are non-phonetic, meaning they are not spelled as they sound, which significantly complicates vocabulary acquisition. Many medical schools leave medical vocabulary learning to the students without instruction on how best to learn the required vocabulary.

Displaying the words in a sentence as meaningful groups may reduce the time, effort and eye movement to understand a complex document, and improve comprehension outcomes.

### Encoding

In some languages, every letter in the alphabet of the language, makes only one sound. In some languages like English, where there are 42-45 phonemes (depending on definition), and only 26 letters, some letters make more than one sound. The term “usual sound for a letter” means the most common sound that the letter makes. The usual sounds for the 26 letters in English are shown in FIG. 11B. FIG. 11B lists the sounds of English Vowels saying their name. FIG. 11C lists the sounds of English digraphs. In English, the letter A can make the sound in “at” and the sound in “ape”. When A makes the sound in “ape”, it is described as “a saying its name”. The characters on the left column of the three tables (FIGS. 11A-11C) can be used to phonetically spell out the sound of every word in English to a high degree of accuracy.

Some linguists have introduced characters like the schwa, which sounds like the sound the character “a” in the word “about”. It has a sound similar to the sound the character “u” makes in the word “up”. To simplify the system, fine distinctions like the schwa above have not been adopted.

To make a phonetic word mark up system intuitive, instead of assigning new symbols which need to be learned to inform a reader what the sound a character makes in a particular word, instead symbols are used in this disclosure that represent a specific sound that is known to the reader. Symbols with a known sound are characters in an alphabet that is known to the reader. In the example of English, characters could include:
a. English characters (if the reader is a native English speaker or knows the sound of English characters),
b. IPA characters if the reader knows the IPA, or
c. characters from the native language of the reader if each character makes the same sound as an English phoneme.

In English, many words are not pronounced as they are spelled, with some characters making the sound of other characters—these may be described as having sounds that are not unambiguously specified by characters in the base alphabet. Take the English word “any” for example. To be able to pronounce the word “any”, a reader needs to know that the letter “a” is pronounced as the usual sound of the letter “e”, the letter “n” makes its usual sound, and the letter “y” makes the sound when the letter “e” says its name. Because characters can make different sounds, a reader needs to know how each character in an English word is pronounced. The English characters in the left column of the three tables make one and only one sound, and are used to uniquely indicate to the reader that the associated character makes in an English word.

Therefore the information to recognize the English word “any” are 3 character pairs (a:e) (n: n) (y: E) which indicates that the character “a” in “any” makes the usual sound of the letter “e”, “n” makes its usual sound, and “y” makes the sound of the character E saying its name. This character and pronunciation information forms a novel composite phonetic alphabet made up of character pairs representing the character in the English word as the first character (referred to herein as “the spelled character” or “spelling character”, or “base character”) and the second character representing the sound that the first character actually makes (referred to herein as “the sound character”). The term “Fonetic Alphabet” refers herein to any composite alphabet made up of, i.e., including/comprising character pairs. The term “Fonetic English” usually refers herein to the composite alphabet where the spelled characters and the sound characters are English characters, however, in some instances Fonetic English is used to mean both Fonetic English and Fonetic Alphabet. Examples of Fonetic English characters are set out in FIG. 12, which includes example words that have been marked up using compound characters (which are described hereinafter), not including example words where a compound character has not yet been used to mark up a word.

With this information suitably displayed, including syllable breaks and silent characters, people with a knowledge of the usual sounds of English letters and digraphs are able intuitively to accurately decode the sound of any character within a written word in English with little or no learning.

The composite alphabet can be further extended by adding as sound characters from other alphabets. For example, the Japanese and English alphabets share a number of common phonemes. To assist a Japanese learner to learn the English alphabet, an English sound character could be replaced by the Japanese character making the same sound as the English phoneme. There is a character (or combination of characters) in International Phonetic Alphabet (IPA) that makes the sound of every English phoneme, so an IPA character or IPA characters could be used as the sound character in the Fonetic English alphabet, which may be of assistance to a person who knows the IPA and wishes to learn the sounds of English characters.

Disclosed herein are methods to capture data about how to pronounce non-phonetic English words in a Fonetic Alphabet format and in particular, English words using English spelling characters and English sound characters (called the Fonetic English format herein), and various display rules that can be used to display the words in the Fonetic English format in an optimal way.

The principles of displaying a word in a Fonetic Alphabet and in particular the Fonetic English format are to keep the spelling and shape of the original word intact so that it can be recognized by sight, add information to tell a reader the sound a character makes in a word, and do not add information that is redundant. For example, if a character in an English word makes its usual sound, then it can be displayed as the spelled character with no sound character as the sound character is not needed. One way of displaying the spelled character with the sound character is to have the spelled character as a smaller superscript character. However other ways of displaying the sound character are possible, including superscripts, subscripts, placing the sound character wholly or partially within the spelled character, and a combination of the above.

The English alphabet is not a complete representation of all English phonemes or the sounds made by particular phonemes.

There is currently no way to distinguish the usual sound of a vowel (/a/and in “at”), and the vowel saying its own name (/a/as in “ape”). In Fonetic English, a capital as a sound character vowel says its name, and a lower case vowel as a sound character makes its usual sound.

There is no character in English that uniquely makes the sound of oo in “foot”, or the sound u in “put”, which is the same sound. Fonetic English introduces a new digraph oo to represent the sound of oo in “foot”, or the sound u in “put”. Experiments were run using oo in different fonts to distinguish oo as in “too” from oo as in “foot”. The most recognizable was to use the Greek letter lower case sigma.

In addition, there is no character in English to display the difference between the unvoiced th in the word “with”, or in the voiced word “them”. A small speaker symbol is used to indicate voiced “th”. This does not change th sound, but the way the sound is spoken.

In order to create the compound characters needed for Fonetic English, obscure Unicode characters are selected and edited using a system developed to efficiently create the required Fonetic English characters.

Silent characters are not displayed differently from other characters.

Syllable breaks are not marked in English, leading to ambiguous pronunciations. Syllables are marked in Fonetic English with a solid syllable mark indicating a stressed syllable, and a hollow syllable mark indicating an unstressed syllable.

The pronunciation of words marked up using other technologies, e.g., with glyphs as described in WO 2012/071630 A1 (ACCESSIBLE PUBLISHING SYSTEMS PTY LTD) 7 Jun. 2012 (referred to herein as “Readable English”), is ambiguous because stressed syllables are not marked. There is only one syllable mark in Readable English whilst there are two in Fonetic English. This is important as the word CONtract (the capitalized syllable is stressed) has a different meaning to conTRACT. There is no way to mark up the two different versions of the word “contract” in Readable English.

With the features herein described above, the Fonetic English alphabet can represent every English phoneme explicitly and unambiguously using a sound character known to a reader, regardless of the spelling character. This means any word in English or in another language can be marked up in Fonetic English or in a Fonetic Alphabet. There are no exceptions. Fonetic English can be thought of as a word and phoneme coordinate that explicitly, unambiguously, accurately and precisely defines the sounds of English phonemes, syllables and words, like the Cartesian coordinate defines 3 dimensional space.

Contrast this with Readable English: the word “one” cannot be marked up in Readable English as can be seen in Appendix B of WO 2012/071630 A1 (Appendix B), thus if one were to automatically generate a translation database for Readable English, the database generation system would need to look up every word to see if it is an exception (like “one [wun]”) and show the sound of the exception words differently, and this would affect the user interface and the processing speed—in contrast, with the Fonetic Alphabet, there need be no exception words as all phonemes can be represented by sound characters, and any sound character can be added to a spelling character.

Additionally, because the F.E. sound characters and spelling characters do not need to be learnt, unlike the glyphs/non-character symbols of Readable English, a word marked up in F.E. explicitly, unambiguously and accurately describes the word sound, so the marked up word is all that is needed to be displayed to represent the sound.

Furthermore, because there are no exceptions and because a word in F.E. represents the sound of that word, there are fewer operations required and the user interface is simpler in use. For example, when the interactive computing system described herein displays the word “one” for a user/learner, the screen would display “one [wun]” for Readable English (see WO 2012/071630 A1, Appendix B), whereas an equivalent system using F.E. would display the word “one” with a “wu” sound character over the “o” and a silent “e” as shown in FIG. 12 (see “o says wu”, FIG. 12 (which incorrectly shows “o says w”)), and similarly for other exceptions in Readable English, to show all words in F.E.

In addition, Words in F.E. take up less screen space than Readable English exception words, and the structure of the page is unaffected (because in R.E. the length of the word differs from the source text because of the addition of the exception in [ ]).

Further, the size of the font database is the same because in F.E. the character set can be defined based on an adaption of a Unicode font.

Additionally, when the interactive computing system described herein reads words aloud, e.g., by the text-to-speech system described herein, any exception words such as “one [wun]” in Readable English-which cannot be sounded out like the word “cat” which is sounded out as/c/, /ca/and /cat/—require a second sounding out system or a much more complex sounding out system that would probably not be as intuitive for users, and teaching the sounding out of “wun” does not teach sightword recognition—in contrast to the equivalent example of “one” marked up using F.E. (see “o says wu”, FIG. 12).

Furthermore, the system using F.E. can display explicitly and unambiguously display everything a reader needs to know about the sound a word makes using letters whose sound the reader already knows as described below.

In addition, the system using F.E. can inform the reader what sound a character in a word makes without the reader having to learn anything. Sound characters are novel to Fonetic English and Fonetic Alphabets. The degree of novelty is significant. Glyphs over Roman characters have been used by Europeans for many hundreds of years. There is no language that solely uses characters whose sounds are known to the reader to indicate the sound of a spelling character when it does not make its usual sound in a word. In Fonetic English and Fonetic Alphabets, each spelling character that has a sound in a word other than its usual sound has the sound character to unambiguously inform the reader what sound that spelling character makes in that word. There is only one way to inform a reader what the sound of a character is: the sound character above the spelling character. There is a one to one or isomorphic relationship. The reader knows the sounds of the alphabet, and so knows what sound the sound character makes without having to learn anything.

In the system using Readable English, symbols, not letters, are used to indicate the sound of a word that does not make its usual sound. Some of these glyphs were borrowed from European languages such as c cedilla (ç) and e acute (é) from French and o with an umlaut ö from German (pages 23, 24). Many of the other glyphs were made up. The sounds of these glyphs need to be learned.

However, the use of glyphs may not be consistent (see WO 2012/071630 A1):
a. on page 23, the sound of the letter “a” /ay/as in “ape” can be represented in 2 different ways: ā and é;
b. on page 23, a, e, o, u and y with a dot above them represented the sound/i/as in “it”—on page 24, g with a dot above it made the sound on/j/as in “jug”; and
c. in Appendix B, it is clear that a glyph makes more than one sound: a makes the sound/ay/as in “ape”, e makes the sound/ee/and in “be” and o makes the sound/oh/and in “go”.

As a reader already knows the sound of the characters in the alphabet, a reader can learn Fonetic English or other Fonetic Alphabets in minutes or hours. Learning the glyphs can be a slow task often requiring weeks.

Using Fonetic English or other Fonetic Alphabets reduces the complexity of the learning/publishing software algorithms/automated processes described herein. Being able to mark up all words in a language and having an isomorphic relationship between glyph and letter sound, as with Fonetic English or Fonetic Alphabets, it is much easier to develop sophisticated algorithms than trying to build these relationships with a mark up system that has many to many relationships and multiple exceptions.

By displaying the spelling and sound characters unchanged, and by keeping the shape of the word the same as in standard English, readers (e.g., of an academic document) may read the document marked up into Fonetic English as if it were in Standard English, but if they come across a new word, they can sound out that word and quickly develop sightword recognition. It is important for fast reading that the English word shape is preserved. It is important for learning new words that all the information about the sound of a word is explicitly and unambiguously displayed for simple and accurate decoding of the word sound by a reader.

Readable English is limited to the English language whereas the approach exemplified by Fonetic English can be used for multiple foreign language pairs.

Prof John Sweller, the founder of Cognitive Load Theory has this to say “I was exposed to Readable English several years ago, as were a large number of academics (many of whom were focused on finding better teaching practices), teachers, students and members of the public. Readable English accomplished the task of providing us with an almost completely phonetic English alphabet while still permitting those who had learned the original alphabet to read the new alphabet without additional training. That was a major advance, but it was an advance made at the expense of students having to learn that new alphabet. I assumed the next hurdle, the construction of a new alphabet that did not require additional learning by students, to be impossible. For me, Fonetic English constitutes a revelation that I never expected to see. I did not make the jump from Readable English to Fonetic English, nor did any of the people exposed to Readable English, which is likely to be in the thousands. In my opinion, Fonetic English is novel.”

Prof Jon Sweller writes: “I founded Cognitive Load Theory (CLT) which is an experimentally developed theory focusing on how to efficiently transfer new information from working memory to long term memory, a process that underlies learning and understanding. Working memory can process no more than 3-4 elements of new information at a given time and can hold that information for no more than 20 seconds before it needs to be refreshed. These limitations disappear when working memory deals with familiar information previously stored in long-term memory. Learning outcomes are statistically significantly improved when students are presented with instruction according to the principles of CLT. Fonetic English uses CLT's principles to structure instruction.” Having all the new information displayed in the one place allows the information to be refreshed without the learner having to stop learning to refresh the information. Learning can be assisted by breaking up learning tasks into smaller sequential learning tasks to minimize new information in working memory. Overloading working memory with too much information stops learning.”

Disclosed herein is a specific instance of a method of converting/encoding a text document, the method including:
a. receiving data representing a source text that includes a plurality of human-readable characters in a base alphabet forming a plurality of words;
b. encoding the source text by:
   i. for each word in the source text (i.e., in a word-by-word search of a database of words and for each word, the word marked up as a phonetic word—the translation database) that has one or more characters (“spelled characters”) that are identified as having a sound other than a usual sound for that character (that is, they are not unambiguously specified by characters in the base alphabet), using a replacement word with respective compound characters (a compound or combined character is a character containing both a spelled and sound character different from the spelled character, and combined together as a new character) that each include the spelled character and a sound character (which can be represented by a superscript), wherein the sound characters:
      1. are human-readable characters in the base alphabet and/or in one or more secondary alphabets (the sounds of whose letters are already known to a reader), each representing a sound in the base alphabet (and each sound character represents the same sound in the base alphabet regardless of which spelled character it is above—for example, the superscript “i” can be used with both of the following spelled characters in English because they both have the same sound/phoneme: “e” in the word “English” makes the sound/i/, and “o” also makes the sound/i/in the word “women”),
      2. have a selected secondary font/character size smaller than a base font/character size selected for the spelled character in each compound character, and
      3. are added to the compound characters such that the spelled characters remain human-readable such that the spelled character and the sound character of each compound character are within one visual field (this means that a reader does not have to move their eyes to see both characters); and
c. outputting the encoded text in a human-readable form/format (including electronic display and/or a printed page) such that the encoded text includes the plurality of words from the source text with the compound characters visually indicating which of the spelled characters have a sound other than a usual sound (for that character), and such that shapes of the words in the encoded text are substantially the same as shapes of the respective words in the source text.

When English is the language of the source text (and thus base language, which may be referred to as “Fonetic English” herein), the human-readable characters in the base alphabet include: a, b, c, d, e, f, g, h, i, j, k, l, m, n, o, p, q, r, s, t, u, v, w, x, y, and z.

For computational simplicity, every compound character is given a unique ID which has two components: the spelling character and a number that refers to the sound character. In an example, a0 is a silent a, a1 makes its usual sound, a2 says its name, and a3, a4, a5 etc. all refer to the spelling character a with a different sound character, which could include characters from different alphabets. In addition, a1i indicates that the symbol represented by a1 is presented as italic, a1b is bold, and a1c is bold italic as shown in FIG. 13.

The names of example compound characters are set out in FIG. 12. The compound character (a:o) is called/a/says/o/, where/a/makes the sound in the word “at” and /o/makes the sound in the word “off”. To make the table in FIG. 12 more readable, /a/says/o/is displayed as “a says o”. In addition, the name of a compound character can be specified with reference to a word or sounds it rhymes with. For example, in the word “coin”, the sound/o/makes rhymes with /oy/, the sound of the word “boy”. If a person knows the sounds of the English phonemes, they intuitively know the name of each compound character.

The sound character (font) size and the spelled character (font) size are fixed in relation at least such that the sound character (font) size is smaller than a spelled character (font) size, e.g., at least 2 points smaller; however, the absolute (font) sizes can change, e.g., based on a selected printing font size for the physical book, and/or a user-selected digital font size for the electronic book, e.g., with the compound character and marked-up phonetic words defined using a TrueType™ font.

The method may include printing the physical book and/or storing the electronic book in a non-transient computer-readable medium, e.g., on a CD ROM or a memory stick, on a hard drive or on a cloud server.

The encoding of the text can be performed at the word level, including marking up the words automatically using specific processes, e.g.: if there is only one vowel, it is a one syllable word and there is no syllable breaks; if the word is being translated into the IPA and there are the same number of IPA phonemes (characters or digraphs representing an English phoneme or sound) as in the English word, there are no silent characters in the IPA.

Where it may be difficult to discriminate superscript characters, different fonts can be used to make the superscripts easily recognizable and distinguishable. For example, if there are two superscripts U and u, if they were in the same font, it could be hard to recognize which is which because the only difference is the size of the superscript. For example, a curly u over an “a” means a small u making the sound as in/up/, a larger straight U makes the sound/you/, i.e., says its name. The characters are easy to see because the lower case vowels are curly and smaller, and the uppercase vowels are straighter and larger. Readers are accustomed to recognizing even little capitals and can distinguish the capitals from little lowercase characters because the fonts of the superscript characters look different. Some superscripts like O and o can be distinguished by their roundness and by their placement: the lower case o can be round and sits in the centre of an uppercase A, when the capital O can be more elliptical and sits slightly to the side of the A.

The sound characters (which can be displayed as superscripts) are selected to be at least 6-8 point in size. The spelling characters are selected to be at least 2 points larger than the sound characters. In addition to the spelled characters being larger, the spelled characters are in a straight horizontal line (as words are currently displayed in typeset documents), and the superscripts only occur when there is a sound character to be displayed, and its placement varies with the spelled and sound characters.

A Japanese-fluent reader learning the sounds of English characters may select—as part of the initial alphabet English-characters with Japanese characters over them (i.e., Japanese sound characters) so they learn the sounds of the English characters that are the same as Japanese characters. This would be chosen so that there was a mapping of English to Japanese for some characters (i.e., with Japanese sound characters), and Japanese to IPA for the other characters (i.e., IPA sound characters) if the reader knew the IPA.

For example, for someone who knows English and the English phonemes, the system does not need the second alphabet to read English words marked up phonetically—the spelling characters and the sound character come from the same base alphabet. The use of the second alphabet is to teach the sound syllable association between the base alphabet and the second alphabet—e.g., telling a Japanese speaker that a particular English character makes the sound of the Japanese character (second alphabet) added to the English character (base alphabet).

The preselected character set may include:
a. a plurality of sound characters in the secondary alphabet associated with spelling words in the base alphabet (also referred to as the “primary alphabet” herein) for common phonemes that exist in both alphabets, i.e., for spelling characters in the primary alphabet that can be defined/pronounced using characters in the secondary alphabet (e.g., as set out in the table in FIG. 4 with Japanese sound characters and IPA sound characters);
b. a plurality of sound characters in the primary alphabet associated with phonemes in the primary alphabet for phonemes that do not exist in the secondary alphabet; and/or
c. a plurality of sound characters in the primary alphabet associated with phonemes in the IPA for phonemes that do not exist in the secondary alphabet. (Thus, if there is a sound that is in English but not in Japanese, then the method can use English characters or use an IPA character. Accordingly, the preselected character set may be a combination of primary alphabet (English) spelling characters with sound characters in the primary alphabet (English), the IPA and the secondary alphabet. If an English speaker is learning say Italian or Spanish, the Spanish or Italian sounds can be spelled to reasonable accuracy for English speakers using English sound characters. “LL” in Spanish make the sound/y/, and in Italian, “ce” as in “cello” makes the sound/che/. The system and method can include foreign alphabets using Roman Alphabets with sound characters that tell an English speaker the approx. sounds made by the foreign words.)

The reader pronounces the compound character following the usual sound represented by the sound characters (superscript), which might be one or more characters, and the sound characters (superscript) represent the same sound regardless of which spelling characters they have been added to.

The sound characters can include diphthongs, e.g., “th”, “oy” “ow”, “ch”, “sh” etc, which may be a set of characters, optionally typeset as an overlapping combination, e.g., “æ”.

The compound characters displaying the character pairs, which in the above example are the spelled characters with sound character (superscripts) as well as the Roman spelling characters when these characters make their usual sound, effectively define a new alphabet with combinations of characters from one or more alphabets, e.g., English, IPA, other language characters and Roman Alphabet/Roman Alphabet characters from different primary and secondary alphabets which both use the Roman Alphabet. An example is the Fonetic English Alphabet which is set out in FIG. 12.

The method shows the sound of a character with another character that is already understood by the reader. The phoneme set may be based on the secondary alphabet such that they are appropriate for teaching the primary alphabet to speakers of the secondary alphabet. If a foreign language speaker is learning English, the sound/character association can be taught by having English as the primary language (defining the base alphabet) and the foreign language as secondary language (defining the second alphabet). Once the sound/character association has been taught/learned, then the foreign language speaker is able to use English characters as both the primary and secondary alphabets, or could continue to use English as the primary alphabet and the foreign language characters as the secondary alphabet. In electronic form, a custom alphabet best suited to the reader can be selected by the reader or by an AI system based on reader usage information collected by the system. Documents that are printed locally can have a customized alphabet. With bound books in printed form that require print runs to be produce cost effectively, a cost effective solution is to have English as both the primary and secondary alphabets. But individualized print solutions for bound books can be provided by using print on demand.

The phoneme set may include, in the superscript sound characters, a plurality of each Roman character in the base alphabet, wherein these characters in the plurality are mutually visually distinguished by a font, including a bold font, an uppercase font, a cursive font, and/or an italic font. For example, vowels may have two sounds (e.g., their usual sound/a/as in/at/ and /ay/as in/day/), so/a/may be shown as a superscript “a” and /ay/as “A”. For example, to differentiate the characters “u” and “U”, the method and system use different fonts with the capital character an upright capital and the lower case character a visually different representation (e.g., a more curvy representation), i.e. using a different font to make it clear which is an uppercase and which is a lower case vowel. See FIG. 11B to see the way in which the 5 vowels of English “say their name”.

The plurality of compound characters thus formed may be referred as a compound alphabet or alphabets that enable the reader to decode the sound of the word with the identified phonemes by visually indicating the sound to the reader in a manner that may minimize additional learning of symbols by the reader. In the case of someone learning English, this alphabet may include characters with sound characters from a plurality of mutually different alphabets, e.g., English, the IPA and a non-English alphabet. What is important is that the shape of the word in English looks the same without the superscripts and with superscripts, i.e., the shape of the word without mark-up looks the same compared to the shape of the word with mark-up. This is necessary to efficiently develop sight word recognition.

The primary alphabet may be English and the secondary alphabet may be English, e.g., for native English speakers to manage the decoding of the sound of non-phonetic English words and by foreign alphabet speakers who have mastery of the sounds of English letters. The primary alphabet may be English and the secondary alphabet may be the International Phonetic Alphabet, e.g., for foreign language speakers who know the IPA. The primary alphabet may be English and the secondary alphabet may be a non-English alphabet, thus using the non-English language characters to tell the reader what sound is being made for those sounds which are the same in the non-English language and English. The primary alphabet may be non-English and the secondary alphabet may be English. Both the primary alphabet and the secondary alphabet may be non-English and mutually different, e.g., Hindi alphabet characters and Japanese sound characters. However, as English becomes the lingua franca, more focus is on English to a foreign language and a foreign language to English. The most common format may be English with English sound characters.

The phonemes of a language are the sounds the language uses to create word sounds by using an ordered set of phonemes to create a word. In an alphabetic language, every phoneme can be represented by one or more characters. There are no words whose cannot be represented by the characters in the alphabet of that language. Take English for example. By extending the alphabet to spelling and sound characters, every word in English can be represented by a set of character pairs of English characters. Take the non-phonetic word “colonel”. It can be represented as a set of character pairs: <sbst><c: c><o: ur><l:0><o:0><unsb><n: n><e:e><l:l>. The character pairs <l:0 (zero)> and <o:0 (zero)> indicate that the l and o are silent characters which is explained below.

The adding of the one or more sound characters includes adding a gap/space between the sound characters and the respective spelling characters such that the words in the encoded text are clearly visible and not touching the sound characters (e.g., so the ink of a printed sound character has a visible gap from the ink of its corresponding spelling character), or selecting a maximum overlap so that is less than 5%, and optionally less than 1% of the length of the character, i.e., the length of a 2 dimensional character in an xy plane is the character's projection onto the 1 dimensional x plane.

The space between the spelling character and the superscript allows the shape of the word in which the spelling character sits to be clearly visible. The space does not have to be on top of the primary alphabet character, for example, it can use the space between the uprights on the character U above the lower portion of the character U.

The spelling characters (e.g., English spelling characters) are bigger than the sound characters (e.g., superscripts) so the reader can clearly see the shape of the word in which the spelling character sits (e.g., the English word in the source text), e.g., as shown in FIG. 4. Problem characters are lower case u and uppercase U and lowercase o and uppercase O. The sound character (e.g., a superscript) may be arranged in different positions for different compound characters: e.g., the lowercase o can go on the top of an A but the capital O can go a little to one side.

The sound characters (e.g., superscripts) are smaller and may be shaped differently from the spelling characters, e.g., straight and curly, the lowercase “o” is round but the capital O is more an oval shape 0. In the case of the “curly u”, if the two dimensional curly u in the xy plane is projected onto the x plane, then the curvy u exceeds the projection of the straight u with the same width and height by 5%. With the oval O, the width of the horizontal cross section is at least 10% smaller than the height of the vertical cross section.

Keeping the word in which the spelling character sits in the source text allows and encourages the development of sightword recognition (seeing the word and instantly knowing its sound and meaning), and once sightword recognition has developed, the sound characters are no longer required. In other words, the encoded text retains the source text such that the words in the source text can be read by sightword recognition even after the sound characters have been added, thus allowing the reader to use the sound characters if they need to (e.g., if there is a word they do not recognise by sight) but simultaneously allowing the reader to read the words they do recognise by sight (thus faster). FIG. 7A shows 3 paragraphs from Alice in Wonderland. As shown in FIG. 7B, the words in FIG. 7A are in the encoded text (in this example, in Fonetic English outputted text) and retain the shapes of the words in the original source text in FIG. 7A: e.g., “the” retains the same shape in the source text and the encoded text and can be easily read by people who can read English words by sight. The size and placement of the sound character superscripts do not interfere with eye tracking. For example, in a word like “conversations”, which has considerable markup, interference with sightword recognition or eye tracking along the line of text in which that word appears is minimal. (It should be noted that solid syllable breaks are not displayed, and that in some words, syllable breaks have not been displayed (e.g., the word “pleasure” in the second paragraph and there are some other irregularities, e.g. the word “close” was not translated into Fonetic English.)

The outputted text in human-readable form/format may include a properly formatted printed document, a printed and bound book with text and a cover (i.e., a printed with ink on paper) that can be printed in a print run or printed on demand, and an electronic book (i.e., displayed on a computer/e-reader screen, including a PC, laptop, Kindle device, tablet or mobile phone).

The method may provide a phonetic encoded text, even if the source text is non-phonetic (e.g., plain English) by unambiguously telling the reader what sound a character makes, when it does not make its usual sound, by adding the sound characters.

The method may also include: adding syllable breaks; and retaining/showing silent characters. The method may include identifying syllables in the source text, and adding spaces/syllable breaks between adjacent syllables in the encoded text.

The silent characters are retained, but may be de-emphasized by using a visual differentiator from the spelling characters that is consistent for the silent characters in the word/text, without changing shapes of the silent characters, e.g., using a different font colour, e.g., grey instead of black. There are multiple ways of indicating silent characters with some examples shown in FIG. 8A. Other ways of indicating silent characters include showing an outline of the character, a different coloured outline (e.g. grey), reverse video, different font, different character size and so on. It is also possible to indicate a silent character using single or double strike through, using outline, a different font, by crossing it out with a watermark, such as an X, or placing an x above the silent character in a similar position and with a similar shape as a sound character. Examples of different ways to indicate a silent character and different ways to indicate a stressed or unstressed syllable are shown on FIGS. 8A and 8B. It is possible that users of a logographic language, such as Mandarin or Japanese may prefer different ways of indicating a silent character than people whose native language is alphabetic, which can be experimentally determined.

A syllable break at the beginning of a word is only be necessary if the first syllable of the word is stressed. Syllable breaks, and stressed and unstressed syllable breaks can be shown in a large variety of different ways, with some examples of stressed and unstressed syllable breaks shown in FIG. 8B.

In digital type, an “Em” is a space, subdivided into a grid, referred to as Units Per eM (UPM) size. With 12 point type, the eM is 12 point, and not the specific size of a character within the eM. For example, a 12 pt Verdana character is larger than a 12 pt Calibri character. The UPM for True Type fonts is often 2048, which means that there are 2048 grid rectangles in each eM.

As shown in FIG. 3, examples of the compound characters may be formed of the following pairs of sound characters and spelling characters:
a. a sound character “e” above a capital spelling character “a” (i.e., “A”);
b. a sound character “e” above a lower-case spelling character “a”;
c. a sound character “s” above a capital spelling character “c” (i.e., “C”);
d. a sound character “s” above a lower-case spelling character “c”;
e. a sound character “J” above a capital spelling character “d” (i.e., “D”);
f. a sound character “J” above a lower-case spelling character “d”;
g. a sound character “A” above a capital spelling character “e” (i.e., “E”); and
h. a sound character “E” above a lower-case spelling character “e”.

In FIG. 3, the left hand column shows compound characters with the spelling character an uppercase character and on the left hand column, the spelling character is a lowercase character. The box around the letter represents the size of the eM and in the example in FIG. 3 the height of every character is 3700 UPM for all spelling characters without or without a superscript.

The vertical height between the base of the EM and the base of the spelling character (excluding the descender) is represented by the numeral 1, and in the example in FIG. 3 is 500 UPM. In the current example in FIG. 3, the font is selected for the spelling characters, and the spelling characters appear in compound fonts unchanged, including the descenders of lower case letters, which is why they are not separately marked. Therefore the vertical spaces represented by numerals 1 and 2 are not changed from the original spelling font, whether uppercase or lowercase, with or without descenders or ascenders.

The vertical spelling letter height is represented by the numeral 2, and in the example in FIG. 3 is 2000 UPM for uppercase spelling characters and for lowercase spelling characters with ascenders.

The vertical space between the top of the spelling character and the base of the sound character is represented by the numeral 3, which is 150 UPM for uppercase spelling characters and for lowercase spelling characters with ascenders (the lowercase letter “d” has an ascender that is 500 UPM high, so that the character has the same overall height as an uppercase letter). For lowercase spelling characters without ascenders, the vertical space between the top of the spelling character and the base of the sound character is 200 UPM.

The vertical height of the sound character is represented by the numeral 4, and is 700 UPM except for the special cases of the vowels o and U which are discussed below.

The vertical distance between the top of the sound character and the top of the eM is represented by the numeral 5, and with uppercase spelling characters and lowercase spelling characters with ascenders, the height is 350 UPM. With lowercase spelling characters without ascenders, the height is 800 UPM.

In the current example in FIG. 3, the ratio of the height of the superscript sound character is 700 UPM compared to the height of an uppercase spelling characters and lowercase spelling characters with ascenders is 35%, and the ratio of the height of the superscript sound character is 700 UPM compared to the height of an uppercase spelling characters and lowercase spelling characters without ascenders is 46.6%.

There are exceptions to a standard sound character superscript size, including the following.

With digraphs, such as “ur” or “or”, the limiting dimension can be the digraph character width, not the height.

It is possible to increase the width of the spelling character slightly (5% or less) as increases above this amount can affect the horizontal spacing of characters and therefore the shape of the word.

Spelling characters in words are separated with vertical separation spaces. Superscript sound characters that are digraphs are treated as a single character so vertical separation space between digraph characters is not required. For example, the digraph “oy”, the “o” and “y” can be fitted more closely together by having a curved separation line, enabling a larger superscript.

The lowercase letter “o” and the uppercase “O” are more easily visually discriminated by having the lowercase “o” substantially smaller than the usual superscript size, and by making the uppercase “O” an elliptical shape, keeping it as the same size as the other superscripts and for certain characters like uppercase “A” locating the uppercase “O” to the side of the A. The smaller “o” can be easily recognized as it is a circle and is always centred over the spelling character. A similar exception is made for the character “U”.

As described above, the lowercase vowel represents the usual sound of a vowel and the uppercase vowel makes the sound of its name. To make the superscript vowel characters easier to visually discriminate, the lower case vowels are presented in a “curly” font. The uppercase character “I” can be presented in a serif font to make it easier to visually discriminate.

There is a tradeoff with the size of the superscript character: the larger the superscript sound character, the easier it is to recognize, but the more the superscript sound character may impact the easy recognition of the word shape. The strategies to overcome this include the following.

There are a limited number of spelling and sound character combinations that actually occur in English words: the spelling character “a” can make the sound/o/as in the word “watch” but there is no word yet found where “a” makes the sound “t”. When there is just one sound character found, such as the spelling character “z” saying “zh”, a reader seeing “z” with a sound character may quickly learn it is the character pair<z: zh>. The spelling character “d” can have two character pairs <d: j> as in “dew”, and <d: t> as in “baked”. In these cases, the reader may quickly learn to discriminate the “D” and “T” used as superscript sound characters. With only a small amount of practice, the reader may start to recognize the combined spelling and sound character, which enables faster reading and smaller superscripts. Larger superscripts may be helpful for people when they first encounter Fonetic English.

As noted above, where there are multiple sound characters for a spelling character, e.g., with vowels, the size of the superscript characters can be reduced without losing recognizability of the compound character by choosing the shape of the superscript sound characters to be easy to differentiate from other sound characters associated with a particular by their shape, the font and the position of the superscript sound character relative to the sound character.

The size of characters can be manipulated in many electronic displays, allowing the reader to size the compound character to best suit their eyesight and reading styles. Print on demand also allow scaling of the size of the compound characters for optimization for individual readability. A smaller print run with fewer pages in a book may be provide a lower cost print edition for people with moderate to good eyesight, and a large print edition can be produced print on demand for those who prefer larger type. Multiple Fonetic English fonts can be produced with different sized sound character superscripts, although these additional fonts may not be needed.

The reader may select a size of font such that they can read the superscript. Small characters are hard to discriminate and can slow the speed of a reader, especially when the reader is first introduced to the Fonetic English font and comes across a new word that they need to sound out. The reader generally needs to visually discriminate both the spelling character and the sound character to sound out the word. Once sight recognition for those words has been achieved, the reader may be able to read the word using just the spelling characters.

As shown in FIG. 3:
a. the example sound characters may be 24% to 36% of the size of the capital letters of the spelling characters-measured vertically from a bottom of each character to a top of each character;
b. a 12 point uppercase spelling character produces an approximately 22 point compound character with a 4.2 pt superscript sound character;
c. the uppercase spelling characters are approximately 5 mm, with the superscript sound characters approximately 2.1 mm;
d. superscript sound characters should be at least 1.8 mm so they can be visually discriminated by a significant number readers with normal eyesight; and
e. the size of the sound characters should be 3.7 point or more so that they can be visually discriminated by the reader.

A variety of different compound characters can be created for the same character pair which have different sizes of the spelling character and the sound character, different sound and spelling character fonts and different locations of the sound character relative to the spelling character. There are several ways that the best compound characters can be selected for a reader which include the following:

A user can interactively select online the Fonetic English compound character font that the user judges is easiest for the user to read by choosing one or more of the Fonetic English compound character font options.

Another selection method is to flash compound characters onto a screen and have the user select the compound characters that are the easiest to read.

A further way to select compound characters that best suit the reader is to present text in different Fonetic English compound character fonts, which the user can read and is tested to see which Fonetic English compound character font is fastest for them to read and/or provides the highest comprehension score.

The collection of this empirical data may allow machine learning systems to be trained to intelligently suggest fonts to users to improve their reading fluency and comprehension.

As explained above, the superscript sound characters can be in different alphabets, such as Japanese and Mandarin. Larger superscripts may be needed where the superscript sound characters are very intricate or where two characters may look alike. An alternative is to use a combination of different alphabets, replacing a character that looks similar to another character with say the IPA or a Roman character.

The method described herein adds the sound characters to the spelling characters, rather than replacing the characters as one would when translating a text into the International Phonetic Alphabet (IPA), so the spelling characters from the source text remaining legible in the encoded text, so the encoded text is at least as easy to read as the source text for a reader of the primary alphabet (in contrast to IPA, which needs to be learned separately, and words represented in the IPA do not look anything like words in the base alphabet (spelling characters)). As the encoding method does not change the spelling of the source text, (this is why the method doesn't delete the silent characters, i.e., silent characters are retained to keep the original words in the source text in their original shapes but are de-emphasized to show they are silent characters) when a reader sounds out a word and develops sightword recognition of that word, the reader recognizes the word by shape, and can read that word whether it is encoded (or “marked up”) or not: in other words, the encoding process adds information to the source text without removing or moving any of the original source characters. In an example, if the source text is in English, which is non-phonetic, making the English phonetic by showing unambiguously the sounds of a word in the right order in the encoded text may enable an efficient way to teach reading.

Learning how to syllabify words is only needed to enable readers to decode the sound of new words. In the new mark up system, syllables are marked for the reader. When sightword recognition of the encoded word is achieved, it is unnecessary separately to teach syllabification (which is complex to teach with multiple rules and exceptions) because the shape of the word and its sound have been learned. Many people can learn syllabification simply from seeing words broken into syllables without further teaching. A key is to teach sightword recognition: once a reader can recognize a word by sight, the reader can in general read that word in standard English without any mark up.

Furthermore, by adding the sound characters to the spelling characters, i.e., substantially above or below the spelling character (i.e., so they do not substantially overlap when printed with the spelling character), the sound characters lie within the same visual field as the corresponding spelling characters when in the encoded text, thus the encoded text may have the same ocular load (i.e., how much eye movement is required for reading) as the base text, thus the information content of an encoded character can be higher without increasing the ocular load on the reader. The reader can look at (and recognize) the spelling character and superscript/subscript sound character as a single visual unit with a compound character name expressing the sound that the character makes (a says o). This enables the reader to recognize the spelling characters in the word and also be able to sound out the word, efficiently developing sightword recognition.

As the sound characters lie within the same visual field as the corresponding spelling characters when in the encoded text, and when the sound characters are from the primary or secondary alphabet, the level of concentration and/or cognitive load may be minimised relative to reading a text in a pure phonetic alphabet like IPA. If a reader has to concentrate to visually discriminate and recognize a character, the reader may have less concentration for understanding the meaning. A word spelled out in the IPA does not look anything like the word spelled in say the English alphabet. Sounding out a word in IPA does not develop sightword recognition in a base alphabet. Providing the spelling characters with the sound characters may assist recall of the sound character.

The sound characters have been designed to lie within the same visual field as the corresponding spelling characters when in the encoded text, the reader typically recognises the combination as a compound character which makes the sound of superscript character. As the reader becomes more and more familiar with the allowed combinations of spelling characters and sound characters, the reader should intuitively know what the sound character is, because they know there are only certain combinations of spelling and sound characters, and the visual memory part of their brain matches the entire compound character.

The method may include including encoding the source text by:
a. identifying at least one word (“identified word”) in the source text that matches one of a plurality of preselected words in a preselected set of words formed of the base alphabet, wherein the identified words includes at least one stressed syllable and/or at least one unstressed syllable defined in the preselected set (including words with equal stress on each syllable), wherein each syllable includes one or more of the spelling characters, and
b. replacing/adjusting the identified word by adding a dot/square preceding each syllable, wherein the spelling characters of the syllable remain unchanged, and wherein the dot/square for the stressed syllable differs visually from the dot/square for the unstressed syllable.

The diameters of the dots are substantially the width of the thinnest character, usually an i in a sans serif font and no more than 2× the width to preserve word shape.

The method may include showing stress in a word with: a closed dot (or substantially filled dot) preceding a stressed syllable, and an open dot (or substantially unfilled dot) preceding an unstressed syllable; a dot preceding a stressed syllable, and a square preceding an unstressed syllable; an open dot preceding a stressed syllable, and a closed dot preceding an unstressed syllable; or a square preceding a stressed syllable, and a dot preceding an unstressed syllable. When the square is used with the dot, both may be open, both may be closed, or one may be open and the other closed. For example, “CONTRACT” with a stress on the first syllable may be encoded as “[CLOSED DOT] Con [OPEN DOT] tract”, whereas “CONTRACT” with a stress on the second syllable may be encoded as “Con [CLOSED DOT] tract”. Showing which syllable is stressed is important because the word with the stress on the first syllable has a different meaning from word with the stress on the second syllable. One way to show stress is to have a solid dot and a circle. Another way is to have a dot and a square. Any pair of mutually different syllable marks may show the difference between syllable marks. There may be 3 levels of stress: high stress, medium stress and low stress. The closed and open dots may be used while retaining the overall word shape for sightword recognition.

“Fonetic English” (“FE”) refers herein to an alphabet, where the spelling characters and the sound characters are English characters.

As shown in FIG. 5, the method may include automatically generating and displaying to a user, via a human-machine interface (HMI) of an interactive computing system, a word (e.g., “acknowledgement” 502) in the source text together with the corresponding encoded word (e.g., “acknowledgement” in FE 504) in the encoded text, and optionally with the corresponding IPA word (e.g., “acknowledgement” in IPA 506). The method can include providing a user-interface control via the HMI (e.g., a “translate” button 508) that receives an input command from the user to commence/perform the encoding steps of the method. Fonetic English aims to use only absolutely necessary mark up. For example, in FIG. 5, the dictionary has marked up the syllable “ment” replacing the character “e” with a schwa. Pronouncing the syllable without the schwa, i.e., as “ment”, does not confuse English speakers, and is simpler, and so the marked up word is postprocessed to change this schwa mark up back to the letter “e”.

The method may include automatically encoding/marking up an English word into Fonetic English (including silent characters, syllable breaks, stress syllables and the sound each character makes) based on inputs from a dictionary/database of word-IPA pairs, i.e., a plurality of words in the primary language and the IPA representations of those words, e.g., the word “Thoroughgoing” and its IPA representation “/, [symbol] /” (or the word “acknowledgement” 502 and its IPA representation “/ [symbol] /” 506, as shown in FIG. 5), as follows:
a. break the IPA characters into phonemes (sounds) and add in compound characters that make the same sound as the IPA phonemes, e.g., <sbun><θ:th><Λ:u><r:r><.:sbun>< [symbol] :u><′:sbst><g:g>< [symbol] :O><.:sbun><I:i>< [symbol] :ng> for “Thoroughgoing”—or ( [symbol] )′( [symbol] ). ( [symbol] ). ( [symbol] ) for “acknowledgement” 502), where <sbun> means unstressed syllable break with no syllable break indicated as it was at the start of the word, or <.:sbun> means unstressed syllable break with a syllable break marked with “.” in the IPA, and <′:sbst> means stressed syllable break with the stressed syllable break marked with “′” in the IPA;
b. sequentially number phonemes and stress marks (a word has an unstressed first syllable unless the first syllable is stressed), which is the last number in the brackets < > for each character/diphthong in the IPA, e.g., <sbun1><θ:th2><Λ:u3><r:r4><.:sbun5>< [symbol] :u6><7′:sbst7>< [symbol] :g8>< [symbol] :O9><.:sbun10><r [symbol] :ill>< [symbol] :ng12>;
c. add the IPA characters to the primary language characters by referring to the IPA to compound-word translation table (e.g., as shown in FIG. 10) progressively by adding the IPA information showing the sound the spelled characters make which is invariant (which may dramatically reduce the number of possible ways the word can be marked up);
d. the characters th, r and ng are added first because each of these characters makes only one English sound: there are two instances of the character “g”, but only one phoneme making the sound /g/, so the character “g” is left for a further iteration, e.g., Thoroughgoing becomes <Th: θ:th2>o<r:r:r4>oughgoing: [symbol] :ng12>,
e. going from right to left, the first syllable is not marked as stressed so it is marked as unstressed, e.g., an unstressed syllable break follows the character “r”, there is only one character between “th” and “r”, so it must have the sound A, thus “Thoroughgoing” is <sbun1><Th: θ:th2><Λ:u3><r:r:r4><.:sbun5>oughgoi<ng: [symbol] :ng12>,
f. going from right to left, if there are three characters, “ing”, in the last syllable of the English word, the character “i” makes the sound/i/and is preceded by an unstressed syllable break, thus “Thoroughgoing” becomes <sbun1><Th: θ:th2><Λ:u3><r:r:r4><.:sbun5>oughgo <.:sbun10><1:ill><ng: [symbol] :ng12>
g. continuing the progression from right to left, the next two phonemes may be O and /g/, and the two English characters are “o” and “g”, so the IPA phonemes can be added to these characters, thus <sbun1><Th: θ:th2><o: Λ:u3><r:r:r4><.:sbun5>ough<g: [symbol] :g8><o: [symbol] :O9><.:sbun10><I:ill><ng: [symbol] :ng12>
h. continuing the progression from right to left, a stressed syllable break can be added in front of the second “g”, thus <sbun1><Th: θ:th2><o: Λ:u3><r:r:r4><.:sbun5>ough<′:sbst7><g: [symbol] :g8><o: [symbol] :O9><.:s bun10><i: I:ill><ng: [symbol] :ng12>,
i. by counting the phonemes, it is clear that the characters “ough” make 1 sound: /u/with the characters “0”, “g” and “h” are silent and the character “u” makes its usual sound/u/, thus <sbun1><Th: θ:th2><o: Λ:u3><r:r:r4><.:sbun5><o: 0><:u [symbol] :u6><g: 0><h: 0><′:sbst7><g: [symbol] :g8><o: [symbol] :O9><.:sbun10><i: I:ill><ng: [symbol] :ng12> (where <o: 0>, <g: 0>, and <h: 0> indicate that o, g and h are silent.) (The US pronunciation is slightly different: in the 6th entry the “u” is silent and the character “o” makes the sound /O/.)

Checking the mark up with the automated checks includes:
a. Checking is there an IPA character or IPA characters in the IPA mark up that is not in the IPA to FE (Fonetic English) translation table? (An English phoneme may sometimes be represented by different IPA symbols.)
b. Checking that the characters pairs in the spelled word marked up into Fonetic English are all valid character pairs
c. Can the IPA be extracted from the marked up word by taking the middle character from the mark up, together with the syllable breaks?
d. Can the English word can be extracted by taking the first character in the brackets < >?

The words marked up in the IPA may not comply with the standards of Fonetic English for the following reasons:
a. there can be mistakes in the IPA dictionary mark up. For example, in one well known dictionary, the word “acknowledge” is translated as / [symbol] /, which has 3 syllable breaks; however, the word “acknowledgement” in that same dictionary has only one syllable break / [symbol] /; and
b. the objectives of dictionaries marking up words are different from those of Fonetic English—the aim of many standard dictionaries is to have the pronunciation as close as possible to the way the word is pronounced by an English speaker in the country where the dictionary is published.

The objectives of Fonetic English may include the following:
a. To make the marked up word as easy to read as possible. This means that additional information about the sounds of words is added only if not adding this information makes it impossible to decode the sound of the written word. In turn this means that if the original spelling can be decoded so that the word when spoken is recognizable, then additional sound characters are not needed. Take the word “real” for example. One mark up for the word in an IPA translation is “rE.ul” where the character “a” is made a schwa. But this is an unnecessary addition, as the marked up word “rE.al” can be decoded to make a sound very similar to the sound “rE.ul”.

b. To make prefixes, suffixes and root easily recognizable. The word “getting” is marked up in some dictionaries as “get.ting”. The Fonetic English mark up is “get.ing” (with the second t a silent character). This has a several benefits: the suffix “ing” is clearly distinguished, which reduces the number of syllables a student needs to learn, and clearly identified the suffix “ing”, and the root word “get” is clearly recognizable.

c. To standardize the mark up of the root words to make then as recognizable as possible. Take the word “real”. The following mark up is in different dictionaries “rE 1” (the “e” says its name, one syllable with a silent “a”), “rE.ul” with the “a” a schwa, and “rE.al” with the unstressed “a” making its usual sound. The word “reality” is marked up as “rE.al∘i∘tE” with the “a” in “real” stressed and making its usual sound. Therefore the most consistent mark up of the root word “real” is “rE.al”, and this mark up is therefore selected for Fonetic English.

d. To mark the word mark up consistent with methods currently used to teach reading. There is a system called “The Science of Reading” where there is a specific mark up. An open syllable is a syllable that ends in a vowel or a vowel diphthong. The vowel in an open syllable usually says its name, e.g. paper, where the word is pronounced pAoper. In closed syllables, the vowel tends to say its usual sound. If there are 2 valid mark up options, then the preference is to use the open and closed syllable mark up.

The marked up words can be checked programmatically (automatically, in a computing system) using one or more of the following methods:
a. Translating the IPA mark up from more than one dictionary, or from other systems such as the word mark up developed by DARPA, and comparing the translations. If there are differences, then these words are edited automatically by the computing system (including machine learning derived algorithms) and/or edited manually.
b. Using computer comparison tools to locate and standardize words marked up with prefixes and suffixes. For example, “getting” can be standardized to “getting” with the second “t” as a silent character.
c. Using computer tools to analyze the marked up words to locate root words like “real” discussed above to ensure that the mark up of the root word is as simple and standard as possible. For example, the mark up if the word “real” is “real”, replacing the sound character schwa in the IPA version with the original sound character being the same as the spelling character. This can be done automatically by changing the mark up of the root word automatically to a predefined and then having the changed checked automatically by comparing it to similar words or checked manually or both.
d. Comparing the mark up of words with the same root to check that the mark up is consistent for the root, e.g., comparing the translation from IPA of similar words, like “acknowledge” and “acknowledgement” to check that the mark up is consistent. In the above described example, additional syllable breaks can be added to the translation of the word “acknowledgement”.
e. Checking for syllable break rule compliance, including automatically, in the computing system, checking that a word with one vowel is a one syllable word, and/or checking that word with multiple vowels that are separated by consonants has the same number of syllables in the mark up as there are vowels. Every syllable has a vowel. So a word with one vowel is necessarily a one syllable word. A word with 3 vowels that are separated by consonants has 3 syllables. A word with only 2 adjacent vowels is likely a one syllable word, but it is possible that there could be a syllable break between the vowels, although this has a low probability. Words which do not comply with the open and closed syllable rule should be highlighted for inspection by an editor.
f. If a new syllable is created, then the word with the new syllable can be checked, so the method includes flagging the new syllable for manual checking. New syllables in which all the spelling characters are the same as the sound characters are likely to be correct, and has a lower priority for checking than syllables in which some spelling characters have different sound characters.
g. The mark up can be checked against an audio recording of the word. This can be done by playing the syllables in the marked up word being checked and comparing the word sound created in this way against the audio recording of the word. If there is not a match, different word sounds can be generated using differently marked up syllables whist still preserving the word spelling. Words with the same root can be marked up using the following process:
   i. A comprehensive table of prefixes and suffixes is created and the suffixes and prefixes are marked up, e.g. “ly” makes the sound “∘lE”. Some prefixes and suffixes can have more than one syllable e.g. the prefix “inter”, and the suffix “ectomy”.
   ii. A search of a comprehensive dictionary for a root word like “real” locates the words containing this root word, called the searched words.
   iii. The root word is marked up and the marked up root word (with syllable breaks as needed) replaces the root word in the English word.
   iv. The prefixes and suffixes can in the English word can be replaced by the marked up prefixes and suffixes (with the syllable breaks but not so there are 2 syllable breaks which are not separated by a character).

A word can be checked manually or by comparing that word to the mark up of that word derived by the IPA mark up process discussed above.

In English, American English differs from British English in spelling (color vs colour), pronunciation (path is pronounced parth in English), and in stress. American and British versions of the English alphabet may therefore be required.

Further customization is possible, e.g., for regional pronunciation or for specific dialects.

The mark up system algorithm described herein may be heuristic and so may be improved each time a correction is made, so that the mark up accuracy increases as the number of marked up words increase.

When enough words have been marked up using the operations described above, the marked up words may be used to train a machine learning system to edit words marked up into Fonetic English using the above operations, and suggest accurate mark up for new words. The training information may include:
a. for each English word, the English word and one or more IPA representation of the sounds of the English word, and, if available, the word correctly marked up into Fonetic English;
b. multiple IPA representations to assist in the detection of errors in the IPA mark up and to assist in selecting the least complex Fonetic English mark up;
c. analysing the mark up of root words (e.g., “real” described above) to ensure that the mark up is consistent across all the words that contain the root word;
d. the table of prefixes and suffixes, and their mark up;
e. a database of the syllables in the marked up Fonetic English and their frequency, which enables the machine learning system to give higher probability to the syllable with the higher frequency; and
f. a database of rules, such as each syllable must have at least one sound, each syllable must have at least one vowel, each prefix and suffix must contain at least one syllable, if there are two vowels in a word and these vowels are separated by a consonant, there must be 2 syllables, is the root word consistently marked up across all the words that contain the root (see the discussion of “real” above), and so on.

The machine learning mark up system can be extended to be trained on the sounds of marked up words, syllables and phonemes, and pronounced words and syllables as described above.

The method may include automatically generating a database of words with compound characters, each including a sound character by:
a. receiving each word written in English (“English word”) and written in the international phonetic alphabet (“IPA word”);
b. comparing characters (“English characters”) in the English word to characters in the IPA word to identify whether one or more characters have a sound other than a usual sound (for that one or more characters), and if so
c. using a compound character instead of the English character to automatically generate a word (“marked-up phonetic word”) that includes the spelling character and a sound character, wherein the sound characters:
   i. are human-readable characters in the base alphabet and/or in one or more secondary alphabets,
   ii. have a selected secondary font/character size smaller than a primary font/character size selected for the spelling character in each compound character, and
   iii. are added to the compound characters such that the spelling characters remain human-readable such that the spelling character and the sound character of each compound character are within one visual field;
d. outputting a database of English words and marked-up phonetic words such that shapes of the marked-up phonetic words are substantially the same as shapes of the respective English words.

The same process can be used to mark up words in languages other than English for which there is an IPA marked up word, wherein the method received each word written in the other language, compares characters in the other language, and outputs a database of words in the other language.

The method may include providing a user interface of the human-machine interface (HMI) for a user to manually select marked-up phonetic words for the English words, e.g., as shown in FIG. 6, thus manually generating the database of marked-up phonetic words. The mark up system allows an editor to select appropriate sound character for the spelling character in a word, which either is greyed out (meaning it is silent), has a sound character superscript, which indicates the spelling character makes the sound of the sound character superscript, or the spelling character by itself, in which case the spelling character makes the usual sound of the spelling character. The lower boxes between the spelling characters indicate unstressed syllable breaks, and the upper boxes indicate stressed syllable breaks.

With documents that are not standard typeset documents, e.g., children's picture books or comics, where text might be in artistic fonts and may not be horizontal or vertical, converting the text to Fonetic English fonts may include (in order to substantially retain the look of the book/page):
a. machine scanning a page of the non-standard typeset document, and using automatic optical character recognition (OCR) convert the non-standard typeset text on the page to machine readable English text;
b. converting machine readable English text to Fonetic English as described herein;
c. automatically comparing (by a first program) the machine readable English text with the text in Fonetic English, and automatically creating a table of additional markings that are needed for each word on the page, which could include adding sound characters, syllable breaks or changing the colour of silent characters; and
d. automatically and directly inserting (by a second program) the additional information into the non-standard typeset text on the scanned non-standard typeset page with:
   i. the size and location of the sound characters calculated based on the size of the type of the non-standard typeset text, with the default location based on the location of the sound characters in the Fonetic English font (in addition, irregular type may require that the second program changes the location to fit the situation),
   ii. new characters superimposed over a non-standard typeset character (in the non-standard typeset text) to indicate a silent character, for example, a letter is imaged, converted to a light grey and them superimposed over the existing character in the non-standard typeset text, or alternatively the silent character could be lightly crossed out so that it does not substantially change the shape of the word, and
   iii. syllable breaks added where there is room for them, which may involve the syllable breaks being added lower than the syllable breaks in standard Fonetic English, e.g., substantially under the spelling characters.

An example of how words can be marked up into Fonetic English without changing the original typeset words is set out in FIG. 9B. A portion of a page of a book is reproduced at the top, and the words in this page portion are marked up into Fonetic English and displayed in the lower portion. Marking up non English words can be important. Non English words includes names, especially foreign names of people and places, and include product and process names, and trademarks. Many of these words have ambiguous pronunciations. This may be especially important with pharmaceutical names where poorly pronounced names could cause injuries. One process to efficiently mark up names such as pharmaceutical names is to use marked up syllables to create a list of potential pronunciations for the name, and have the trademark or product name owner choose the mark up or choose the mark up and then edit the mark up.

### Adding Other Information to Improve Reader Comprehension

In the period 800-1200 CE, two developments enabled silent reading: putting spaces between words and the use of upper and lower case letters in words. Prior to word spaces, readers had to run their eyes back and forth along a line of characters to identify individual words. Breaking sentences into phrases reduces the need for readers to scan the words in a sentence to locate phrase breaks.

The publishing system can also present sentences broken up into meaningful groups of words, which are called phrases in this document even though some academics may hold the opinion that some groups of words would not technically be phrases. As stated above, breaking sentences into phrases is of considerable assistance when the sentence is long, complex and/or convoluted, because even skilled readers may need to read a sentence several times to determine where the phrase breaks are. Adding phrase breaks may assist readers who are reading a foreign language especially if that foreign language has a different word order than their native language.

Sentences can be broken into phrases by:
a. using punctuation in the sentence; and/or
b. recognizing conjunctions like “because” which usually start a new phrase: conjunctions like “and” are more complex as they may denote a phrase break where two sentences are joined together in one sentence by using an “and”, or may not denote a syllable break e.g. in the phrase “bat and ball”.

Analysing the grammatical structure of a sentence using a tool like AutoMap developed at Carnegie Mellon University to be able to classify each word by its parts of speech, and then using this information to group words into phrases, e.g., nouns and adjectives may for the subject of a sentence, verbs and adverbs may be grouped together, and nouns and adjectives grouped together as the object of the sentence. This is the way to classify the effect of conjunctions like “and”.

Academic, legal, regulatory, technical and other documents may contain long streams of words in a sentence between punctuation marks and other phrase marking words, such as conjunctions. The heuristic process to develop accurate phrase detection software includes:
a. analysing a number of academic, legal, regulatory, technical and other documents using punctuation and conjunctions, and select large word strings where syllable breaks are not detected;
b. in the sentences where these large word strings occur (and the sentence before and after that sentence), phrase breaks are marked by at least one expert; and
c. these phrase breaks are used to develop better algorithms to mark phrases by developing new algorithms and testing the algorithms to see if the new algorithms correctly mark the phrases, and are amended until the phrase breaks are correctly inserted.

The process described in the paragraph above may be repeated with new data and new corrections, which update the algorithms to increase accuracy. Once a reasonable mark up accuracy has been established (e.g., 95%), beta test documents with mark up can be made available to teachers and academics to correct the phrase breaks manually. This additional data is added to the system to further improve the algorithms. This process described in this paragraph and the paragraph above can be extended to students marking up documents, preserving accuracy by using a statistical algorithm to accept only those phrase breaks that have a high probability of being right, e.g., if 3 students given a document all mark up the same phrase breaks. Once sufficient data have been collected, the collected data can be used to train a machine learning system to analyse text and break it into phrases.

There are many ways that phrase breaks can be displayed in multiple ways including such ways as retaining the text format but increasing the word spacing between phrases to indicate a phrase break, using an easily recognizable symbol, such as ⋄ phrase 1 ⋄ phrase 2 ⋄ to separate the phrases using the same block format, or by displaying each phrase on separate lines.

Breaking sentences into phrases is an example of the Comprehension Improvement Tools in step 12 of the Method 100 and is further explained below.

Testing and Practice to Support Readers Using Documents from the Publishing System

Reading, writing, listening and speaking a language are all interrelated. Improvements in one area may improve other areas. Data collected in exercises in one area can often be used in other areas. For example, if a student cannot accurately discriminate the sound of a word, they are unlikely to be able to accurately pronounce it, so exercises to pronounce that word are prioritized only after the student can accurately discriminate the sound of that word. Because of the interrelationships, a system that provides publishing and language-learning features must also be an interrelated system.

The ability to explicitly, precisely and unambiguously define the sound that a word makes, the ability to explicitly, precisely and unambiguously mark up all words in a language, and the ability to explicitly, precisely and unambiguously represent the sound of a character in a word even if it makes a sound other than its usual sound, and without changing the spelling, the ability of the reader to know and understand the characters and the phonemes represented by the characters, enables a simplified display as the display of a marked up word is also a display of the sound of the word, enables faster computer operations because there is an isomorphic relationship between the phonemes in a word and the phonemes, and enables explicit, precise and unambiguous exercises to be created. For example, the exercises and tests to improve listening skills (auditory discrimination) and speaking skills (pronunciation) described herein may be much more effective with the explicit, precise and unambiguous mark up of phonemes, syllables and words using the mark up system described herein which is known to the user.

The heuristic, comprehensive, integrated publishing and language-teaching system for reading, hearing speaking, spelling and vocabulary has a number of new algorithms that use the phonetic alphabet described herein. These new algorithms may include:
a. an intelligent, heuristic lesson scheduling system;
b. an intelligent, heuristic word mark up system;
c. an intelligent, heuristic vocabulary teaching system; and
d. intelligent, heuristic exercises that rely on the display of the word unambiguously expressing the sound of the word to a reader, for example, how to blend phonemes into a syllable.

Other examples are described herein.

Described above are a number of ways that an alphabet can be created that contains additional information and can be used to assist readers to learn to read a language, learn a language more efficiently, efficiently improve their language skills, and/or better comprehend documents written in that language. In order to assist a particular class of readers, or individual readers, information needs to be collected in the User Progress Database, step 9 of Method 100, and analysed to heuristically optimize learning and comprehension outcomes.

The heuristic methods to achieve the optimization of learning activities of the Method 100 Step 8, Exercise Skill Improvement Database, Step 10, Vocabulary Improvement Tools, Step 11, Reading Improvement Tools and Step 12, Comprehension Improvement Tools include:
a. measure what a class of people (or an individual) know and what they don't know and teach what they don't know e.g. does an individual know what sound a particular character makes;
b. measure the skill levels of individuals or classes of individuals e.g. how well can someone accurately discriminate the sounds of particular phonemes; and/or
c. the number of times a person needs to learn something for that knowledge to be stored in their relatively non volatile long term memory.

The optimization of the learning activities of the Method 100 Step 8, Exercise Skill Improvement Database, Step 10, Vocabulary Improvement Tools, Step 11, Reading Improvement Tools and Step 12, Comprehension Improvement Tools may involve interactive learning modules and this interactivity enables the system to progressively record and analyse information such as:
a. information about what a person needs to know e.g. they are studying medicine and they need to acquire a medical vocabulary;
b. information and/or predictions of what a person knows, and what they need to know, from which the system can calculate what they don't know and need to know;
c. their current skill levels; and/or
d. what revision plan works best for that individual person or group of individuals with similar learning profiles.

Step 9 of the Method 100 is the User Progress DB. This system logs everything and logs the answers and compares the answers to the correct answers and decides whether the answer is correct or not.

The method of logging and storing user information may include:
a. receiving user inputs from a user of a computing system which the computing system stores;
b. the computing system generating measured values of the user's knowledge/performance;
c. the computing system classifying the user into one of the plurality of categories based on the measured values; and
d. the computing system predicting what activities are optimal for the user based on the stored user data of users in the same category or categories.

An example of the method of logging and storing user information may include:
a. receiving user inputs from a user of a computing system;
b. the computing system classifying the user into one of a plurality of categories based on the user inputs; and
c. the computing system selecting the alphabet characters from the plurality of alphabet characters based on the user category using a predefined mapping between user categories and character sets.

Another example of the method of logging and storing user information may include:
a. the computing system presenting a test text in the primary alphabet to the user by displaying the test text visibly or playing the test text audibly, wherein the test text includes: a plurality of words that can be selected by the user using the user interface (“user-selectable words”) including at least one test word and one or more distractor words (which are not the test word); and
b. the computing system measuring the values from user selections of the user-selectable words, including measuring how many of the least one test words are user selected, whether the at least one test word was correctly chosen, and/or how much time is taken to select the test words.

Another example of the method of logging and storing user information may include generating the measured values by:
a. the computing system displaying a plurality (e.g., 3) marked up words, a subset (e.g., 2) of which are wrong; and
b. the computing system measuring how many correct and incorrect words the user selects. The incorrect words are logged in a database and the system continues to reteach these incorrect answers until the answers are correct, say 3 times in a row.

The exercises answered correctly can be presented to the user occasionally to revise the correct answers to ensure they are retained in long term memory, as even long term memory requires revision but less frequently. This can be measured and an individual pattern is developed to ensure long term memory retention with minimized time spent in revision.

Another example of the method of logging and storing user information may include generating measured values by:
a. the computing system playing the sound of a word with a plurality of syllables (e.g., a multi-syllable word with at least 2 syllables, e.g., a 3 syllable word) defining a corresponding plurality of correct syllables (e.g., at least 2 respective correct syllables, e.g., 3);
b. the computing system displaying a corresponding plurality of blank boxes (e.g., at least 2 respective blank boxes) and a plurality of user-selectable syllables greater than the corresponding plurality (i.e., there are more user-selectable syllables than blank boxes, e.g., more than 2 or more than 3);
c. the computing system receiving input from the user selecting a corresponding plurality (e.g., at least 2, or 3) of the user-selectable syllables;
d. the computing system measuring how many of the correct and incorrect syllables are in the user-selected syllables; and
e. reteaching the incorrect syllables until they are learned, thus until the measured number of incorrect syllables is below a selected threshold (the correct syllables are revised occasionally as discussed above).

This process (the above example of the method of logging and storing user information) can be used to teach spelling, i.e., being able to have the correct syllables selected so that the spelling characters accurately spell out the word and the sound characters make the correct sound. This process can be used to improve sightword recognition, and enable a student to detect misspellings because “the word doesn't look right”.

Another example of the method of logging and storing user information may include generating measured values by:
a. the computing system playing the sound of a word defining a first plurality of correct characters;
b. the computing system displaying blank boxes equal to the first plurality;
c. the computing system displaying a second plurality of user-selectable characters, wherein the second plurality is greater than the first plurality;
d. the computing system receiving input from the user selecting the user-selectable characters; and
e. the computing system measuring how many correct characters are in the user-selected characters.

This process (the above example of the method of logging and storing user information) can be used to teach a student to improve their sightword recognition and recognize the word correctly spelled. This allows the student to detect a word that is misspelled because “the word doesn't look right”.

Another example of the method of logging and storing user information may include generating measured values by:
a. the computing system playing the sounds of a respective plurality of words with a time of silence between adjacent ones of the played sounds of the words;
b. the computing system reducing the time of silence between the played sounds based on the input from the user;
c. the computing system playing the sounds of the words slowly in a continuous sound (as used in human to human speech) based on input from the user with the tone corrected for speed (with some audio players, as the speed is slowed, the tone of speech drops); and
d. the computing system playing the sounds of the words at the speed of normal speech in a continuous sound (as used in human to human speech) based on input from the user.

The computing system can take a word and pass the word to an automated text to speech software module that is configured to produce an audio file containing the sound of the word which can be stored in a database linking the word text to the word sound. A sentence can be played one word at a time by selecting a word, looking up the database for the sound of that word, and playing that word. The sentence as played does not contain intonation and cadence.

The computing system can take a sentence and pass the sentence to an automated text to speech software module that is configured to produce an audio file of the sentence being read aloud with intonation and cadence. The audio file of the sentence can then be passed to an automated speech segmentation system, such as Aligner developed by Dr Stefan Rapp, which can break the continuous speech containing the sounds of the words in the sentence into discrete words and phonemes. Because the intonation and cadence applying to a word can be different in different sentences, a database linking the word to its sound also contains the document identifier, a sentence identifier and a word identifier, which allows the words in a sentence to be played sequentially with cadence and intonation, with a variable gap between the words.

By breaking the audio signal into the sounds of discrete words, and linking the text of the word to its sound in a database, each word in a sentence can be highlighted as its sound is played. This may assist some readers, e.g. those readers who were never read to as children, and helps to improve auditory discrimination be seeing the word and hearing it pronounced. Multiple choice questions can be added to measure the comprehension of the reader.

Playing the sound of a word whilst highlighting the text of the word may be a useful feature in a reading practice tool.

Using the above methodology, a reading practice tool can also play a sentence in phrases whilst highlighting the sentences.

The split concentration principle of Cognitive Load Theory states that information from multiple sources at once can reduce learning because attention is split. Once readers develop some reading competence, attention is not be split if the student only reads, or if the student just listens.

By clicking on a phoneme, syllable, word, phrase, phrasal verb, idiom etc., the reading practice tool could also play individual words, syllable, phonemes, phrases, phrasal verbs (to come up with means to think of) and idioms with or without intonation and cadence.

Similarly, the reader could click a word, phrase, phrasal verb, idiom etc and be presented with the definition or translation of words, phrases, phrasal verbs, idioms etc.

The user inputs may include user-selected values, and the method includes receiving the user-selected values by:
a. the computing system presenting text input prompts and/or selectable lists to the user; and
b. the computing system receiving the user-selected values as inputs in the text input prompts and/or selectable lists,
   wherein the method includes the computing system classifying the user into one of the plurality of categories based on the user-selected values.

In step (2) of the method 100, information about the user collected at registration may include:
a. Name and contact details (phone, email etc.);
b. Country of residence;
c. Native language;
d. Age;
e. Sex;
f. Educational attainment in native language (primary, secondary, tertiary);
g. Professional qualifications;
h. Self assessment of reading ability in native language;
i. Years spent learning English (or other language being taught);
j. Educational attainment in English (e.g., IELTS 5);
k. Self assessment of reading ability in English;
l. Self assessment of spoken English communication in English; and/or
m. What does the user want to learn English for? E.g. to study accounting.

Step 4 of method 100 is the User Classification System which uses information from the Registration System, step 2 of the method 100, to form user groups where the members in the group have similar knowledge and skills.

This allows users to be conveniently categorized into groups by answering a small number of questions, and then the usage data of the group can be used to predict the optimal learning strategies for the new member.

For example, a new user responds to the questions stating their native language is Mandarin, they are 18, male and have IELTS grade 5. By analysing the recorded student data, many students in this category can recognize the English alphabet, have a 3-500 word vocabulary, can accurately discriminate about half the sounds of English phonemes, but find the discrimination of other phonemes problematical. Their pronunciation of English words containing the difficult phonemes is often poor.

From the database recording usage of students, it can be calculated that it is statistically likely that the new user benefits from taking a specific course to improve auditory discrimination, and when auditory discrimination has improved, take a specific course on pronunciation.

The specific auditory discrimination course might teach syllables with difficult phonemes by teaching words with the phonemes that other users in the same group could hear and progressing to more difficult to hear syllables and then phonemes. In addition, a student may be better able to hear these words spoken by someone with the same native language as the user. When the student can accurately discriminate the sounds of syllables and phonemes when pronounced by a person with the same native language, the student can start working with sounds made by a native speaker of the base language, the language being learned.

These predictions can be tested by giving the user activities and recording and analysing the outcomes and then modifying the course based on user data. For example, the user may have better auditory discrimination than the group and not need to have time spent on something the user already knew or had the skills. This user information is then analysed to provide better group predictions in the future, and may cause a larger group to be split into two or more groups with more defined knowledge and skills.

If the user wished to study accounting, a vocabulary list can be generated which the student needs to know. The student is tested on the vocabulary to determine what is known and what needs to be taught and the system predicts what words are known and what words need to be learned and this prediction is tested by the interactive course the user undertakes.

In step 3 of method 100, exercises can provide additional data for classification of users into user groups using the User Classification System, step 4 of method 100, which may include:
a. measuring a user of a computing system (i.e., testing reader knowledge and skills) by:
b. the computing system presenting a test text in the primary alphabet to the user (speaker of the secondary alphabet) by displaying the test text visibly or playing the test text audibly, wherein the test text includes: a plurality of words that can be selected by the user using the user interface (“user-selectable words”) including at least one test word and one or more distractor words (which are not the test word), and
c. the computing system measuring user selections of the user-selectable words, including measuring how many of the least one test words are user selected, and/or how much time is taken to select the test words—wherein the user is the speaker of the secondary alphabet reading the test text (e.g., identifying how many errors and/or what errors are in the text test, measuring a time lag between the word playing and receiving the user selection);
d. the computing system classifying the user into one of a plurality of categories based on the measurements (and optionally based on additional user-selected values, described hereinafter, and optionally using a trained classifier, e.g., a trained artificial neural network, ANN, trained on data from training users in each of the plurality of the user category groups); and
e. the computing system selecting the phoneme set from the plurality of sets based on the user category (i.e., use the category of the user to select the character set for the encoding) using a predefined mapping between user categories and character sets (which is a many to one mapping, as many different groups/categories map to English/English alphabets).

Together the user classification system, step 4 of method 100, data for the user classification system, step 5 of method 100 and user classification algorithm improvement system step 6 of method 100 form and Step 7 of method 100, User assignment to a user group, form a heuristic system illustrated by the following examples.

A Chinese student aged 11 has 3 years of English training. Testing shows that other Chinese students aged 11 with 3 years of English training have difficulty clearly discrimination hearing certain English phonemes but these students can hear a number of syllables containing these phonemes that are pronounced by a native Chinese speaker. It has also been found that if these students learn additional syllables containing the difficult phonemes pronounced by a Chinese speaker, their auditory discrimination improves and that they can then start correctly discriminating the easier syllables when a native English speaker speaks these syllables. The computer system predicts from the usage results of other students that the student should be presented with the same syllables in the same order. As more students use the system, some students may learn more quickly than others, and there may be a fast track for students finding the learning easier. The system analyses the results of the student and, based on the logged usage, provides learning activities to maximize the individual performance of that student.

Further information for the user classification improvement algorithm, steps 5 and 6 of method 100, is illustrated in the following examples.

The training users are asked test questions like “how many errors are this in this short passage of text?”, and the errors they identify are recorded. Based on their answers to these questions from manually categorized users, the ANN is trained to categorize users. ANN categorized users have their usage information logged and to provide information as to the accuracy of the prediction/classification. The data with the manually corrected user classification may be added to the ANN in training.

Once the user registration data and the additional data based on student activity have been received, the user is assigned to a user group in step 7 of the method 100 based on the probability that the user has the best learning outcomes in that group. Once the user is assigned to a user group, the user is assigned a User ID and a group ID.

The English skill improvement database, step 8 of method 100, the Vocabulary Improvement Tools, step 10 of method 100, the Reading Improvement Tools, step 11 of methos 100 and the Comprehension Improvement Tools, step 12 of method 100, use logged user information to select exercises, exercise content, alphabet selection, word selection and priorities based on the calculated probability of optimal group learning outcomes, and when sufficient data is collected, individually optimized exercises, exercise content, alphabet selection and priorities.

For example, using the user information collected as described above, different optimized alphabets for different reader user categories (“groups”) can be provided. Each group (e.g., of language students) has a learning profile. For example, for each language, there may be three (or more) groups: e.g., beginner, intermediate and advanced. By dividing users into groups via the classification system, the teaching steps described hereinafter may be optimized for these users based on their groups by predicting what they know and don't know, teaching what they don't know, and not teaching what they do know.

The classification system can select the phoneme set that is individualized and optimized for the group of individuals based on their age, their language mastery (including of the IPA), their education level, their English literacy (e.g., if someone knows the English phoneme set then they can use the English/English alphabet).

Critical to the method 100 may be the collection of all user registration and activity in a database that can measure user progress which is step 9 in method 100. The data is collected with as much detail as possible and non SQL databases like DymanoDB from Amazon allow for the restructuring the database if required.

The method may include the computing system authenticating and identifying a user by connecting to a learning management system (LMS, e.g., from Blackboard Inc., DC USA) in which the user has a user account, e.g., through an application programming interface (API) of the LMS. The method may include sending the user category and/or the measurements (measured values) to the LMS associated with the user account for storage with a user record in the LMS. There are several formats which can be used here which include: xAPI, Tin Can, Sharable Content Object Storage Model (SCORM).

There are a number of Reading Improvement Tools, step 11 of the method 100 which are described below.

The method described herein encodes text document in a manner optimised for personal learning of a language, e.g., English, based on the language of the learner, e.g., Japanese: thus the encoded text is optimised for each individual/student. The method uses sound characters that are also characters in the primary alphabet (e.g., English) or in the secondary alphabet (e.g., Japanese) so the human reader does not need to learn new symbols (e.g., glyphs).

The method includes testing the user to find the best character set for that user based on their known language (the “secondary language” herein) and other listening, reading and pronunciation abilities.

The reader's mental overheads may be reduced if the symbols have optimal automaticity both in ease of recognition and also in recall of sound. For beginners, characters in the native language of the reader are easily recognizable visually and also the reader knows what sound it makes. So if there are phonemes in the primary language (e.g., English) that are the same in the secondary language (e.g., not English), and if the reader has not mastered English letter/sound association (i.e., the sounds English characters make as their usual sound)—referred to as “full automaticity”, a fast way to learn these sounds is to see the English character and the secondary character making the same sound. (Obviously if there are sounds in English that are not in the secondary language, then there are no characters making those sounds. Either the English characters are used, or IPA characters. The user needs to be taught how to hear and make those sounds. Students cannot self correct their pronunciation unless they can accurately discriminate the differences between their pronunciation and that of a native speaker of the language they are learning.) In addition, the reader may be more confident in hearing and speaking the sounds if they see sounds in their native (secondary) language rather than the IPA if the students are not confident of their knowledge of the IPA. In contrast, countries like Japan and China teach the IPA to their students. The secondary alphabet may be the IPA, e.g., by having IPA characters over Chinese characters.

As the method includes identifying pre-existing reader knowledge, efficiency of teaching the reader the primary language may be improved (it is not efficient to teach someone something they already know). As the method includes classifying the reader into one of a plurality of reader groups (or “categories”), the level of the reader's knowledge may be estimated quickly, with only a few questions.

General comprehension of any language requires accurate auditory discrimination, accurate pronunciation and fluent reading. In addition, nobody is able to understand spoken or written information if they do not understand the meaning of the words used in the communication. Development of vocabulary is essential for improved comprehension. Comprehension Improvement Tools, step 12 of the method 100 provide of efficient ways to improve reader comprehension, examples of which are described below. There is overlap between the tools. An example is auditory discrimination. Improving a user's auditory discrimination improves that user's ability to hear and understand spoken words (accurate listening and improved comprehension of oral communication), improves the pronunciation (accurately discrimination spoken phonemes allows more effective self correction of pronunciation), and knowing how to spell a word enables the user to know what to listen for.

A second example is learning to sound out a word, which improves auditory discrimination, pronunciation and efficiently develops sightword recognition which improves reading fluency and comprehension.

Given the interrelated nature of language learning, a reference to developing a specific skill, e.g., sounding out words, includes the other benefits such as increasing the number of words a user can recognize by sight, improvements to auditory discrimination and improvements to pronunciation.

Examples of the Reading Improvement Tools, step 11 of the method is set out below. The elements of step 11 include:
a. the computing system dividing a word (from the source text, e.g., “cat”) into a plurality of individual phonemes/partial syllables/syllables including the first character/letter and progressively more characters/letters/digraphs (two letters representing a different sound, e.g. the digraph “ph” represents the sound/f/), incrementing by one phoneme (character or digraph other than a silent character) for each partial syllable/syllable (each including the first phoneme of the word plus zero or more phonemes of the word in order, up to reconstructing the full word);
b. the computing system sounding out (playing) the partial syllables/syllables progressively in order of length (e.g., /c/, /ca/, /cat/) from the user interface of the computing system for the user to hear (i.e., playing the sequence) (the symbols/cat/represent the sound of the word “cat” when pronounced by a native English speaker);
c. the computing system instructing the user to repeat the partial syllables/syllables via the user interface;
d. the computing system recording the user speaking the syllables/partial syllables; and
e. the computing system sounding out the set of the partial syllables/syllables and then the set of the user's recorded partial syllables/syllables (e.g., the user's recording of/c/, /ca/, /cat/ and then the official recording of/c/, /ca/, /cat/) and the sounding out step can be repeated two or more times.

Students may need to learn blending: e.g., that/c/, /a/, /t/makes the sound/cat/. Some students already know this, especially students whose native language is phonetic, like Finnish, Italian or Spanish. Most systems do not teach the progressive phoneme blending where a student learns to progressively implement the partial syllable sound phoneme by phoneme/c/, /ca/, /cat/. Usually a student hears/c/ /a/ /t/ and is told this makes the sound/cat/. The current teaching practice requires at least 4 bits of information in short term memory for a three phoneme word. Longer words cause higher loads on working memory and are quickly likely to overwhelm working memory. Cognitive Load Theory teaches that reducing the number of items in working memory increases learning outcomes. The strategy of breaking words into syllables, learning how to blend each syllable, and then pronouncing the syllables quickly one after another to pronounce the word can significantly reduce the load on short term memory. Blending can be taught online using a system where students hear/c/, /ca/, /cat/etc and then they are recorded and they can play back their recordings to compare with a native speaker making the same recording. Some people whose native language is logographic (like Mandarin) may not be good at sounding out words (blending) and these people require teaching.

Computerized voice recognition systems such as those downloadable from www.speechace.com can be used to measure the reading skills of users by measuring the words that were read correctly and those words that were not read correctly, and the accuracy of the pronunciation of users. This information is logged and used to classify users into groups, optimize exercises, predict optimal exercises for particular users, and provide feedback on the accuracy of the predictions.

In learning to sound out words, students learn to read syllables by sight and this means if a student sees a syllable, they instantly know its sound. There are at least 13,802 words made up solely of the most common 500 syllables. For many students, learning just 500 syllables enables them to read basic English. This is vastly more efficient than having to learn 13,802 words individually, especially as many words are non-phonetic and need to be learned by rote, which can take a lot of repetition. The efficiency of the system is further enhanced by the standardization of the Fonetic English mark up, by clearly marking prefixes and suffixes, which makes it easier to decode the meaning of a word, and by the standardization of the Fonetic English syllable breaks, which reduces the number of syllables that need to be learned. For example, the 13,802 words could be made up solely of as few as 450 Fonetic English syllables, thus it may be significantly faster to use Fonetic English mark up to learn the 13,802 sightwords.

Over half of the most common English words are non-phonetic, meaning that these words are not pronounced as they are spelled. These non-phonetic words must be learned by rote, requiring a lot of repetition to learn each word. There are over 5000 words that need to be learned by repetition. Compare this approach to teaching people to quickly learn 500 syllables by sight by sounding them out 2 or 3 times. Syllables are short and easy to learn. Knowing the syllable sounds makes it easy to sound out words, as we pronounce words syllable by syllable. Breaking words into phonetic syllables and teaching the most common syllables is significantly more efficient than the current rote learning approach.

Several word frequency lists have been produced by academics that rank English words by their frequency in documents. Syllables in the most common 1000 words necessarily occur more frequently that those syllables occurring in say the 5000-6000 most common words. A database of all marked up Fonetic English words together with the frequency of the word in English documents is used to generate a database of all Fonetic English syllables with their weighted frequency, which takes into account both the frequency of the words containing a syllable and the number of words in which that syllable occurs. For example, a syllable may occur in 30 of the most common 1000 English words. A second syllable may occur in words whose frequency in English documents is less frequent than the most common 9000 words but more frequent than the most common 10000 words. Clearly the syllable occurring in the first 1000 words is viewed more frequently than words whose frequency lies between 9-10000.

An example of the method of improving reading by using syllabification may include an efficient way of teaching the sounds of a list of words that a user needs to learn, e.g. for a medical course:
a. the words in the list are marked up into Fonetic English if they are not already marked up;
b. the computing system analyses the words in the list and creates a list of syllables together with the frequency that the syllables occur in the list; and
c. the computing system prioritizes the syllables to be taught by giving those syllables that the user is predicted to know a lower priority, based on their user classification.

Students learning English for the first time may be taught the sounds of the most common words and syllables, e.g., the most common 1-200 or more syllables, to significantly reduce the cognitive load required to learn to read because the reader often only needs to sound out a few characters in a new syllable in a new word containing a common syllable.

An example of the method of improving auditory discrimination may include:
a. the computing system displaying characters representing phonemes, syllables and words on the user interface of the interactive computing system, and simultaneously sounding out (playing) the sound files containing the phonemes, syllables and words (the method includes showing the characters so that the user can see what to listen for, and can simultaneously hear the word pronounced, or pronounced syllable by syllable while seeing the words, syllables or phonemes displayed); and
b. requiring the user to take some form of action to provide user input: e.g., hearing a sound and clicking on the collection of characters that best represent that sound.

Auditory discrimination of English phonemes, syllables and words is improved because a student knows what to listen for. Many people have heard a person say their name and were not able to accurately discriminate the phonemes of the name. When given a card with the name spelled out, people can often discriminate what was said. The system may make this easier by also finding out what accents the person can hear and presenting the sounds in the accents a person can hear and then progressively moving the accents towards a native English speaker.

An example of the method to improve auditory discrimination may include:
a. the computing system measuring a user of a computing system (i.e., testing reader skill and knowledge) by:
b. the computing system presenting a test text in the primary alphabet to the user (speaker of the secondary alphabet) by displaying a plurality of test texts visibly (“a” and “e”) and playing one of the test texts audibly (which can be the sound for “a” or “e”), and
c. the computing system measuring user selections of the user-selectable words, including measuring how many of the at least one test words are user selected, and/or how much time, to determine auditory discrimination (e.g., between “a” and “e”); and
d. if the measurement is below a preselected threshold, the computing system providing a plurality of syllables and words with the test texts and additional characters and phonemes (visibly and audibly in one or more accents) for the user to train their auditory discrimination, including providing the plurality of syllables and words starting with short syllables and progressing to long syllables and then words increasing in length.

By recording and analysing the user interactions, the system can intelligently determine which words, syllables and phonemes are problematical, and which are not, and develop different learning strategies for the problematical words, syllables and phonemes which can include using logged user data to intelligently predict other activities to improve learning outcomes, such as different accents, finding words that the user can discriminate, adding difficult phonemes and/or syllables to test whether this improves learning and skill development outcomes and so on.

An example of the method of improving auditory discrimination may include:
a. the computing system selecting phonemes (sounds) that are in the primary alphabet but not the secondary alphabet based on a predefined phoneme chart (or data representing a phoneme chart), e.g., the Japanese phoneme chart in FIG. 4, which may include phonemes of the primary alphabet and phonemes of the secondary alphabet connected or linked by a corresponding IPA symbol making the same sound.

For auditory discrimination, only those sounds that are not the same need to be taught.

An example of the method of improving auditory discrimination may include teaching auditory discrimination by:
a. the computing system playing a test sound for the user to hear;
b. the computing system displaying a plurality of characters including a test character or characters representing the test sounds in the language; and
c. the computing system measuring whether the user clicks on the test character or characters.

An example of the method of improving auditory discrimination may include recording the test sound by someone from the same language background as the student recording the sounds (i.e., whose native language is the secondary language), or by a native language speaker of the primary language. This method may allow the user/student to build new neural networks in the brain when the student can discriminate something approximating the sound, and/or allow the student to be more motivated to practice if they have initial success.

An example of the method of improving auditory discrimination may include recording and playing words and syllables to teach sounds that are in the base alphabet but are not in the language with which the learner is familiar, e.g., not in the secondary alphabet. An analysis of the IPA characters in 2 languages shows what phonemes are the same in each language (“common phonemes”). This information can be used to measure the accuracy of the auditory discrimination of different learners when they hear phonemes, syllables or words containing only common phonemes pronounced in different accents. If a learner can hear accurately discriminate some phonemes in a foreign language, they are able to efficiently expand their discrimination to include other phonemes in a syllable if they can accurately discriminate some phonemes in that syllable. If a learner cannot discriminate a phoneme, simple repetition does not teach that phoneme to that learner. For example, if someone cannot hear the difference between /a/ and /e/, they are likely to be able to hear the difference in words like/cat/ and /ket/if the letters “c”, “k” and “t” are common phonemes. The system experimentally determines what the syllables and words are that are easiest for the student to accurately discriminate by testing different combinations with a lot of students, and using statistical analysis to determine the best combinations for each of the different student groups. The result is an ordered set of syllables that are taught to learners using different accents spoken at different speeds that rapidly, effectively and efficiently build the auditory discrimination skills of the learner.

An example of the method may include teaching auditory discrimination by:
a. the computing system recording the user pronouncing a test character (and/or phoneme/syllable/word); and
b. the computing system repeatedly playing the user's recording for the user to hear;
c. the computing system repeatedly playing a prerecorded pronunciation of the test character (and/or phoneme/syllable/word) after the user's recording such that the user can hear a difference between the user's recording and the prerecorded pronunciation; and
d. the user's recording and the prerecorded recording may be played one after the other.

The prerecorded pronunciation can be pre-recorded in different accents to test what accents the user can hear, and then progress the user to being able to hear all the sounds of the language they want to learn pronounced by a native speaker.

In order to understand what is being spoken, someone listening needs to be able to discriminate the sounds of words as they are being spoken. When a native speaker speaks in their native language, their words are not pronounced one after the other with a space of silence between the words. Instead, the words are run together with a lower volume of sound indicating the separation between the words. When learning a new language, a person must learn not only to discriminate the sounds of individual words, but also to discriminate individual words spoken rapidly when there is no silence between the spoken words.

One way to teach the ability to accurately discriminate words spoken by a native speaker of that language is to teach the sounds of the individual words played independently. This may involve teaching the sounds of the syllables and then teaching the sound of the word by combining the syllables, e.g.:
a. play the sounds of individual words with discrete silences between the words, reducing the duration of the silences between the words;
b. play the sounds of the words as if spoken slowly by a native speaker; and
c. play the sound of the words spoken at a normal rate.

The efficacy of the system can be further improved by having the sounds of the words spoken by someone with the same language as the person learning, and when the learner can accurately discriminate the words spoken with a familiar accent, the learner can then go through the same process with words spoken by a native speaker.

The system can be made more efficient by predicting the words and syllables that the learner is likely to hear based on the experiences of other learners in the same group, and teaching the words and syllables that the learner is most likely to encounter, using the prediction techniques described in this document.

If a person is taught to spell a word, and if they know the sounds of the phonemes and how to blend phonemes, they may master that word. If they do not know the meaning of a word, it is unlikely they are able to understand a sentence in which the word is used. Vocabulary is therefore essential to being able to read and understand a document.

Vocabulary Improvement Tools are step 12 of the method 100 addresses the need for efficient vocabulary acquisition, with examples provided below.

The vocabulary acquisition burden varies subject by subject. In many subjects, the acquisition of vocabulary is a critically important to being able to understand the topic. In medicine, for example, some doctors estimate that vocabulary acquisition is the single most time consuming part of the course.

Vocabulary acquisition is made more difficult because many medical terms are not pronounced as they are spelled. This means that simply recognizing the word and its sound-sightword recognition-takes considerable repetition. Much lower repetition would be needed if the word could be sounded out character by character. So having words marked up phonetically significantly improves any vocabulary acquisition activity. Vocabulary acquisition is also improved by efficiently teaching the sounds of the most common syllables in the list of words students are required to learn.

Recognition is seeing or hearing a word and knowing its meaning. Recall is hearing a definition of a word or seeing an image of a word, and recalling its name. Recognition is easier to acquire than recall and is usually acquired first.

Vocabulary recognition can be acquired by having people pair the marked up word with an image, a definition, a translation or getting the student to fill in the correct word into a sentence, choosing one word from maybe 4 words. Recall acquisition exercises include seeing a definition of a term or an image related to the term, and having to type in the name, i.e., there is no prompt to trigger recognition.

There are various formats to do this. Think of a diagram of the bones in a foot. The system shows students the names of a few bones. Then the system has the names of say 4 or 5 of these bones in a list and they have to click on an arrow pointing to a bone to develop recognition. Then when there is good recognition, the system helps people to acquire recall, as they have to fill in the name by typing without any recognition prompts.

The system can do the same with statistics. Showing lines on a bell curve can show e.g., what a standard deviation is. Eventually the aim is getting the student to learn and understand the equation. Again, going from recognition to recall.

Humans have evolved to remember information they understand far more easily than random information. So separating the acquisition of vocabulary from learning about e.g. the function of the vocabulary terms to be acquired can actually impede long term memory development. Consider the human foot example. If a student needed not just to name the bones, but had to name adjacent bones, and how these adjacent bones could move relative to each other, the student would know a lot more about the foot than the names of the bones on a diagram. Describing how the weight of the body was distributed across the bones of the foot would provide the student with further information about the anatomy of the foot at the same time as acquiring the vocabulary. This kind of understanding requires less repetition and revision to remain in long term memory.

The benefits of a deeper understanding of a vocabulary term, such as in the foot example above, may include:
a. saving student time and effort by acquiring information about a term at the same time as learning the sound or the term as written and how it is spelled;
b. making the vocabulary acquisition process more interesting for the student, so that the student is motivated to spend more time and make greater effort; and/or
c. vocabulary learned in this way is more likely to be able to be recalled for longer with far less revision.

For many people, vocabulary acquisition is to learn a word, forget it, learn it again, forget it again and so on until the word is stored in long term memory. Once in long term memory, there is still a need to revise the word, but this does not require the frequency of repetition to learn the word initially.

There is a need to optimize the repetition needed to put the meaning of words into long term memory, to minimize the student time and effort involved. In order to recall the words in long term memory, repetition is required. When the word is in long term memory, the repetition periods get considerably longer. A heuristic algorithm to minimize the number of repetitions uses student test results where a student with is tested with different words at different elapse times to estimate the elapsed time when the student starts forgetting the meaning of words and ensure repetition and the refreshing of the long term memory happens before the students forgets that word. The heuristic system also analyses data from what the student has read to see how frequently a word has been read, and exercises the student has done that contain that word. The system makes predictions based on a particular student's data, as well as the usage data from the group in which the student has been categorized. These predictions are automatically tested by giving that student particular exercises with that word and at particular intervals. The results of these tests update the algorithms driving the system to make it more efficient.

The method of an integrated heuristic vocabulary acquisition that may contain the following elements:
a. providing a phonetic rendering of the vocabulary terms to be acquired;
b. optimizing the phonetic rendering to make the root word and the prefixes and suffixes easily recognizable and assisting students to understand the meaning of the word by understanding the prefixes, suffixes and the root word;
c. experimentally testing different interactive vocabulary acquisition methods and logging all user activity to create a database that can be used to predict the optimal learning strategy of a group of students and/or an individual student;
d. collecting and analyzing user registration data to create user groups that are predicted to have similar learning outcomes;
e. using the user registration information to assign a new user to a user group;
f. using the usage data collected by members of the group to which the new user has been assigned to predict the optimal interactive exercises for the new user, and the optimal revision regime;
g. experimentally testing the predictions and modifying the predictions for a user based on actual user data; and
h. using this new user data to modify the user group classifications, the predictions based on user group membership and the algorithms driving the system so that the system becomes more efficient.

The method may provide a heuristic, comprehensive, integrated publishing and language-teaching system for reading, hearing speaking, spelling and vocabulary built around a phonetic alphabet with characters meaningful to a group of readers made up of the primary language characters (e.g., English characters) and where the primary language character does not make its usual sound, a sound character (in size) from the primary language, the secondary language, or the IPA, e.g., as a superscript over the primary-language character where the mark up fully, explicitly and unambiguously specifies the pronunciation of a marked up word, every word in a language can be marked up consistently, and because the mark up word is known to readers, the display of the marked up word also displays the sound of the word to readers. This feature reduces the complexity of the interface and reduces the number of operations required to provide the same information if the mark up system did not completely, unambiguously and explicitly define the sound of a phoneme, syllable or word. Having fewer operations means that the computer functions more quickly. In a similar way, the isomorphic relationship between the sound of a word and its phonemes, as specified by the spelling and sound characters, enables simpler computer algorithms with fewer operations. Having fewer operations means that the computer system runs more quickly when the computer system is driving the heuristic publishing and language-teaching system described herein.

### Implementations

The method described herein may be embodied in computer-readable/machine-readable instructions compiled from source code written in the C #programming language.

The method of encoding the text document is performed/executed by a specifically programmed computing system 200.

FIG. 2 is a schematic block diagram of the specifically programmed computing system 200 (“computer system 200”).

In the described embodiment, the system 200 includes a standard computer system 200 such as a commercially available personal computer or server computer system based on a 32-bit or 64-bit Intel architecture, and the processes and/or methods executed or performed by microprocessors of the system 200 are implemented in the form of programming instructions of one or more software components or modules 202 stored on non-volatile (e.g., hard disk) computer-readable storage 204 associated with the computer system 200, as shown in FIG. 2. At least parts of the software modules 202 could alternatively be implemented as one or more dedicated hardware components, such as application-specific integrated circuits (ASICs) and/or field programmable gate arrays (FPGAs).

The computer system 200 includes at least one or more of the following standard, commercially available, computer components, all interconnected by a bus 216: random access memory (RAM) 206, at least one computer processor 208, and external computer interfaces. The external computer interfaces include: universal serial bus (USB) interfaces 210 (at least one of which is connected to one or more user-interface devices, such as a keyboard, a pointing device (e.g., a mouse 218 or touchpad), a network interface connector (NIC) 212 which connects the computer system 200 to a data communications network such as the Internet 220, and a display adapter 214, which is connected to a display device Q322 such as a liquid-crystal display (LCD) panel device.

The computer system 200 includes a plurality of standard software modules, including: an operating system (OS) 224 (e.g., Linux or Microsoft Windows); web server software 226 (e.g., Apache, available at http://www.apache.org); scripting language modules 228 (e.g., personal home page or PHP, available at http://www.php.net, or Microsoft ASP); and structured query language (SQL) modules 230 (e.g., MySQL, available from http://www.mysql.com), which allow data to be stored in and retrieved/accessed from an SQL database 232.

Together, the web server 226, scripting language 228, and SQL modules 230 provide the computer system 200 with the general ability to allow users of the Internet 220 with standard computing devices equipped with standard web browser software to access the computer system 200 and in particular to provide data to and receive data from the database 232. It will be understood by those skilled in the art that the specific functionality provided by the system 200 to such users is provided by scripts accessible by the web server 226, including the one or more software modules 202 implementing the processes described herein, and also any other scripts and supporting data 234, including markup language (e.g., HTML, XML) scripts, PHP (or ASP), and/or CGI scripts, image files, style sheets, and the like.

The boundaries between the modules and components in the software modules 202 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), reduced instruction set computer (RISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the computer system 200 may be executed by a module (of software modules 202) or a portion of a module. The processes may be embodied in a machine-readable and/or computer-readable medium for configuring a computer system to execute the method. The software modules may be stored within and/or transmitted to a computer system memory to configure the computer system to perform the functions of the module.

The computer system 200 normally processes information according to a program (a list of internally stored machine-readable instructions such as a particular application program and/or an operating system) and produces resultant output information via input/output (I/O) devices. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

The data generation, data storage and data communications operations relate to digital data operations. The digital data may include electronic data defined by logic circuits-which may include binary logic circuits-represented by electronic quantities, which may include voltage, current and/or resistance.

Disclosed herein are the following implementations.
Implementation 1: A method of encoding a word to make the encoded word phonetic and intuitive to the reader by encoding the word by:
using respective compound characters that each include the spelling character and a sound character (which can be represented by a superscript), wherein the sound characters:
are human-readable characters in the base alphabet and/or in one or more secondary alphabets,
are added to spelling characters to indicate that the spelling character makes the usual sound of the sound character,
are displayed so that it is easy to discriminate spelling characters from sound characters,
are added such that it is easy for a skilled reader to recognize the word by sight (sightword read the word), and
are added to the spelling characters such that the spelling characters and the sound characters remain human-readable such that the spelling character and the sound character of each compound character are within one visual field; and
outputting the encoded word in a human-readable form/format such that the compound characters in the encoded word visually indicate which of the spelling characters have a sound other than a usual sound (for that character).
Implementation 2: The method of Implementation 1 and adding characters and/or symbols to represent sounds that are not unambiguously specified by characters in the base alphabet.
Implementation 3: The method of Implementation 1 or 2 and adding syllable breaks, wherein the syllable breaks explicitly and unambiguously inform the reader whether the syllable is stressed or unstressed and/or adding a symbol to explicitly and unambiguously inform the reader whether a phoneme or digraph is voiced.
Implementation 4: The method of any one of Implementations 1, 2 or 3 where the syllable breaks are added in a way to minimize the number of syllables.
Implementation 5: The method of any one of Implementations 1 to 4 where the shape of the word as spelled by the spelling characters is substantially preserved.
Implementation 6: The method of any one of Implementations 1 to 5 where sound characters are easily visible so that a reader can quickly and efficiently sound out a new word, and at the same time, the sound characters are displayed so that they do not interfere with the efficiency of reading by a reader skilling in reading words as spelled using the spelling characters.
Implementation 7: The method of any one of Implementations 1 to 6 where a word is fully or partially marked up using the mark up in the IPA of that word.
Implementation 8: A method of converting/encoding a text document, the method including:
receiving data representing a source text that includes a plurality of human-readable characters in a base alphabet forming a plurality of words;
encoding the source text by:
for each word in the source text (i.e., in a word-by-word search of a database of words and corresponding marked-up phonetic words words) that has or more pieces of explicit information about the decoding the sound of that word and
outputting the encoded text in a human-readable form/format such that the encoded text includes the plurality of words from the source text with the explicit information about decoding the sound of that word.
Implementation 9: A method of converting/encoding a text document, the method including:
receiving data representing a source text that includes a plurality of human-readable characters in a base alphabet forming a plurality of words;
encoding the source text by:
for each word in the source text (i.e., in a word-by-word search of a database of word and corresponding marked-up phonetic words) that has one or more characters (“spelling characters”) that are identified as having a sound other than a usual sound (for that character), using a replacement word with respective compound characters that each include the spelling character and a sound character (which can be represented by a superscript), wherein the sound characters:
are human-readable characters in the base alphabet and/or in one or more secondary alphabets,
are added to spelling characters to indicate that the spelling character makes the usual sound of the sound character,
are displayed to that it is easy to discriminate spelling characters from sound characters, and
are added to the spelling characters such that the spelling characters and the sound remain human-readable such that the spelling character and the sound character of each compound character are within one visual field; and
outputting the encoded text in a human-readable form/format such that the encoded text includes the plurality of words from the source text with the compound characters visually indicating which of the spelling characters have a sound other than a usual sound (for that character), and such that shapes made by the spelling characters in the words in the encoded text are substantially the same as shapes of the respective words in the source text.
Implementation 10: The method of Implementation 1 or 9, wherein the preselected phoneme set includes:
a plurality of sound characters in a secondary alphabet associated with phonemes in the primary alphabet that can be defined/pronounced using characters in the secondary alphabet;
a plurality of sound characters in the primary alphabet associated with phonemes in the primary alphabet that do not exist in the secondary alphabet; and/or
a plurality of sound characters in the primary alphabet associated with phonemes in the IPA that do not exist in the secondary alphabet.
Implementation 11: The method of Implementation 1 or 9, including indicating a syllable break.
Implementation 12: The method of Implementation 1 or 9, including indicating a syllable break by adding a symbol preceding the syllable.
Implementation 13: The method of Implementation 1 or 9, including indicating silent characters, optionally by visually differentiating the silent characters from the spelling characters without changing shapes of the silent characters.
Implementation 14: The method of Implementation 1 or 9, including indicating silent characters and syllable breaks.
Implementation 15: The method of Implementation 1 or 9, wherein the adding of the one or more size sound characters includes adding a gap/space between the sound characters and the respective spelling characters such that the words in the encoded text are clearly visible and not touching the sound characters.
Implementation 16: The method of Implementation 1 or 9, including indicating a syllable break, wherein the syllable break indicates if a syllable following the syllable break is stressed or unstressed.
Implementation 17: The method of Implementation 1 or 9, wherein one or more of any lowercase sound characters are shaped differently from the corresponding uppercase characters, including having a different font.
Implementation 18: The method of Implementation 1 or 9, wherein the outputted text in human-readable form/format, including in a physical printed book and/or in an electronic book, optionally including printing the physical book and/or storing the electronic book in a non-transient computer-readable medium.
Implementation 19: The method of Implementation 1 or 9, wherein the sound characters have a font size (“sound font size”) based on a font size (“source font size”) of the source text in a ratio of 6:9 (sound character font size: spelling character font size).
Implementation 20: The method of Implementation 1 or 9, wherein the sound characters have a font size of at least 6 point.
Implementation 21: The method of Implementation 1 or 9, wherein the name of the compound characters are/spelling character/says/sound character/and/or/spelling character/rhymes with/sound character/.
Implementation 22: The method of any one of Implementation 1 to Implementation 20, including:
receiving user inputs from a user of a computing system;
the computing system classifying the user into one of a plurality of categories based on the user inputs; and
the computing system selecting the phoneme set from the plurality of sets based on the user category using a predefined mapping between user categories and phoneme sets.
Implementation 23: The method of Implementation 22, wherein the method includes:
the computing system generating measured values of the user's knowledge; and
the computing system classifying the user into one of the plurality of categories based on the measured values.
Implementation 24: The method of Implementation 23, including:
the computing system presenting a test text in the primary alphabet to the user by displaying the test text visibly or playing the test text audibly, wherein the test text includes: a plurality of words that can be selected by the user using the user interface (“user-selectable words”) including at least one test word and one or more distractor words (which are not the test word); and
the computing system measuring the values from user selections of the user-selectable words, including measuring how many of the least one test words are user selected, and/or how much time is taken to select the test words.
Implementation 25: The method of Implementation 23, including generating the measured values by analysing user pronunciation using a voice analysis tool.
Implementation 26: The method of Implementation 23, including generating the measured values by:
playing the sounds of different syllables containing phonemes to be learned in the order that enabled other students in the same student category to score more correct answers in learning exercises or tests;
playing the sounds in an accent that enables the student to score more correct answers in learning exercises or tests; and/or
when the student can discriminate the syllables and phonemes pronounced in an accent the student finds easier than a native speaker of the base language, transition the student to hearing phonemes and syllables pronounced by a native speaker of the base language.
Implementation 27: The method of Implementation 23, including generating the measured values by:
playing the sounds of different syllables containing phonemes to be learned in the order that enabled other students in the same student category to score more correct answers in learning exercises or tests;
playing the sounds in an accent that the student to score more correct answers in learning exercises or tests; and/or
when the student can discriminate the syllables and phonemes pronounced in an accent the student finds easier than a native speaker of the base language, transition the student to hearing phonemes and syllables pronounced by a native speaker of the base language, by first playing the sound of the syllables and phonemes that the student found easier when listening to a person with the same native language as the student speaking these syllables and phonemes.
Implementation 28: The method of Implementation 23, including generating the measured values by:
the computing system displaying at least 3 marked up words, 2 of which are wrong; and
the computing system measuring how many wrong words the user selects.
Implementation 29: The method of Implementation 23, including generating measured values by:
the computing system playing a multi-syllable word with at least 2 syllables defining at least 2 respective correct syllables;
the computing system displaying at least 2 respective blank boxes and a plurality of user-selectable syllables greater than at least 2;
the computing system receiving input from the user selecting at least 2 of the user-selectable syllables; and
the computing system measuring how many correct syllables are in the user-selected syllables.
Implementation 30: The method of Implementation 23, including generating measured values by:
the computing system playing the sound of a word defining a first plurality of correct characters;
the computing system displaying blank boxes equal to the first plurality;
the computing system displaying a second plurality of user-selectable characters, wherein the second plurality is greater than the first plurality;
the computing system receiving input from the user selecting the user-selectable characters; and
the computing system measuring how many correct characters are in the user-selected characters.
Implementation 31: The method of Implementation 23, including generating measured values by:
the computing system playing the sounds of a respective plurality of words with a time of silence between adjacent ones of the played sounds of the words;
the computing system reducing the time of silence between the played sounds based on the input from the user;
the computing system playing the sounds of the words slowly in a continuous sound (as used in human to human speech) based on input from the user; and
the computing system playing the sounds of the words at the speed of normal speech in a continuous sound (as used in human to human speech) based on input from the user.
Implementation 32: The method of Implementation 22, wherein the user inputs include user-selected values, and the method includes receiving the user-selected values by:
the computing system presenting text input prompts and/or selectable lists to the user; and
the computing system receiving the user-selected values as inputs in the text input prompts and/or selectable lists,
wherein the method includes the computing system classifying the user into one of the plurality of categories based on the user-selected values.
Implementation 33: The method of Implementation 32, wherein the text input prompts and/or the selectable lists define a plurality of user-selectable values defining: age, sex, native language, education level, and/or English or other language skill level.
Implementation 34: The method of Implementation 32 including: the computing system authenticating and identifying the user by connecting to a learning management system (LMS) in which the user has a user account.
Implementation 35: The method of Implementation 34 including: the computing system authenticating and identifying the user by connecting to a learning management system in which the user has a user account through an application programming interface (API) of the LMS.
Implementation 36: The method of Implementation 34, including sending the user category and/or the measured values to the LMS associated with the user account for storage with a user record in the LMS.
Implementation 37: The method of Implementation 24, including the computing system classifying the user into one of the plurality of categories using a trained classifier, trained on data from users in each of the plurality of the user category groups.
Implementation 38: The method of any one of Implementations 22 to 37, including:
the computing system dividing a word from the source text into a plurality of individual phonemes/partial syllables/syllables, including the first character/letter and progressively more characters/letters/digraphs (two letters representing a different sound, e.g. the digraph “ph” represents the sound/f/), incrementing by one phoneme (character or digraph other than a silent character) for each partial syllable/syllable;
the computing system sounding out (playing) the partial syllables/syllables of the phoneme progressively in order of length from the user interface of the computing system for the user to hear;
the computing system instructing the user to repeat the partial syllables/syllables via the user interface;
the computing system recording the user speaking the syllables/partial syllables; and
the computing system sounding out the set of the partial syllables/syllables and then the set of the user's recorded partial syllables/syllables, optionally including repeating the sounding out step two or more times.
Implementation 39: The method of Implementation 38 including:
the computing system displaying characters, syllables and words on the user interface and simultaneously sounding out (playing) the sound files containing the phonemes, syllables and words.
Implementation 40: The method of any one of Implementations 22 to 39, including:
the computing system playing a test sound for a/the user to hear;
the computing system displaying a plurality of characters including a test character or characters representing the test sounds in the language; and
the computing system measuring whether the user clicks on the test character or characters.
Implementation 41: The method of any one of Implementations 22 to 40, including: the computing system selecting phonemes that are in the primary alphabet but not the secondary alphabet based on data representing a predefined phoneme chart (e.g., the Japanese phoneme chart in FIG. 4) including phonemes of the primary alphabet and phonemes of the secondary alphabet connected/linked by a corresponding IPA symbol.
Implementation 42: The method of any one of Implementations 22 to 41, including:
the computing system recording the user pronouncing a test character (and/or phoneme/syllable/word); and
the computing system repeatedly playing the user's recording for the user to hear;
the computing system repeatedly playing a prerecorded pronunciation of the test character (and/or phoneme/syllable/word) after the user's recording such that the user can hear a difference between the user's recording and the prerecorded pronunciation.
Implementation 43: The method of any one of Implementations 22 to 42, including identifying syllables in the source text, and adding spaces/syllable breaks between adjacent syllables in the encoded text.
Implementation 44: The method of any one of Implementations 22 to 43, including encoding the source text by:
identifying at least one word (“identified word”) in the source text that matches one of a plurality of preselected words in a preselected set of words formed of the base alphabet, wherein the identified words includes at least one stressed syllable and/or at least one unstressed syllable defined in the preselected set, wherein each syllable includes one or more of the spelling characters, and
replacing/adjusting the identified word by adding a dot preceding each syllable, wherein the spelling characters of the syllable remain unchanged, and wherein the dot is a closed dot for the stressed syllable, and/or an open dot for the unstressed syllable.
Implementation 45: A method including:
receiving user inputs from a user of a computing system;
the computing system classifying the user into one of a plurality of categories based on the user inputs; and
the computing system selecting an optimal character set whose characters are comprised by spelling and sound characters from the plurality of character sets based on the user category using a predefined mapping between user categories and phoneme sets.
Implementation 46: A method of automatically generating a database of words marked up into a format of any of Implementations 1 to 21.
Implementation 47: The method of Implementation 46, including providing a user interface for a user to manually select marked-up phonetic words for the English words.
Implementation 48: Non-volatile computer-readable storage including machine-readable instructions configured to cause a computing system to perform the method of any one of the proceeding Implementations when the machine-readable instructions are executed/performed by one or more microprocessors of the computing system.

### Interpretation

Many modifications will be apparent to those skilled in the art without departing from the scope of the present invention.

The presence of “/” in a FIG. or text herein is understood to mean “and/or”, i.e., “X/Y” is to mean “X” or “Y” or “both X and Y”, unless otherwise indicated.

The term “letter” and the term “character” have the same meaning in this document, unless a contrary intention is clear from the usage.

A lowercase letter within lines such as/a/represents the usual sound made by the letter “a” in e.g. the word “at”. An uppercase vowel within lines such as/A/says the names of the vowel, such as the sound A makes in the word “ape”.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). Thus, a set includes at least one element. In general, an element of a set can include or be one or more portions of a system, an apparatus, a device, a structure, an object, a process, a procedure, physical parameter, or a value depending upon the type of set under consideration.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

It is to be noted that the discussions contained in the “Background” section should not be interpreted as a representation by the present inventor(s) or the patent applicant that such discussion, or referenced documents or device, in any way form part of the common general knowledge in the art.

The claims:

1. A publishing system with components, including:
a system configured to receive at least one document including text that defines a base alphabet in one or more formats;
a system configured to provide additional data for a reader to better understand the document which includes:
a method of encoding or marking up non-phonetic words in the document to enable the reader to decode sounds of each non-phonetic word; and
a system configured to output an encoded document with the text and the additional data in one or more formats,
wherein the method of automatically encoding the non-phonetic words to make the encoded words phonetic:
for at least one character (“spelling character”) in the non-phonetic word, using a compound character that includes the spelling character and a sound character, wherein the sound characters:
are human-readable characters in the base alphabet and/or in one or more secondary alphabets,
are added to the spelling characters to indicate that each spelling character makes the usual sound of the sound character,
are added so that spelling characters can be visually discriminated from sound characters,
are added such that a reader can recognize the non-phonetic word by sight because the spelling of the word is unchanged, and
are added to the spelling characters such that the spelling characters and the sound characters remain human-readable such that the spelling character and the sound character of each compound character are within one visual field; and
automatically outputting the encoded words in a human-readable form/format such that the compound characters in the encoded word visually indicate which of the spelling characters have a sound other than their usual sound and what sound each character makes in the non-phonetic word when it does not make its usual sound.

2. The system of claim 1, including automatically encoding/marking up an English word into an encoded word, including silent characters, syllable breaks, stress syllables and/or the sound each character makes, based on inputs from a dictionary/database of word-IPA pairs comprising a plurality of words in the base alphabet and the International Phonetic Alphabet (IPA) representations of those words, optionally wherein the encoded/marked-up words are checked by one or more of:
automatically, in a computing system, determining whether there is an IPA character or IPA characters in the IPA mark up that is not in the dictionary/database of word-IPA pairs;
automatically, in a computing system, determining whether the characters pairs in the encoded word are all valid character pairs;
automatically, in a computing system, translating the IPA mark up from more than one dictionary and comparing the translations, and if there are differences, editing the words;
automatically, in a computing system, locating and standardizing words marked up with prefixes and suffixes;
automatically, in a computing system, analyzing the marked up words to locate root words to ensure that the mark up of the root word is standard as possible, including changing the mark up of the root word automatically to a predefined mark up and having the change checked automatically by comparing it to similar words;
automatically, in a computing system, comparing the mark up of words with the same root to check that the mark up is consistent for the root;
automatically, in a computing system, checking that a word with one vowel is a one syllable word, and/or checking that a marked up word with multiple vowels that are separated by consonants has the same number of syllables in the mark up as there are vowels;
automatically, in a computing system, if a new syllable is created, flagging the new syllable for manual checking, including flagging new syllables in which all the spelling characters are the same as the sound characters with a lower priority for checking than syllables in which some spelling characters have different sound characters; and
automatically, in a computing system, playing the syllables in the marked up word and automatically comparing the word sound created in this way against a separate audio recording of the unencoded word.

3. The system of claim 1, wherein the method of encoding includes adding syllable breaks, including indicating a syllable break by adding a symbol preceding the syllable, including adding the syllable breaks by:
identifying at least one word (“identified word”) in the source text that matches one of a plurality of preselected words in a preselected set of words formed of the base alphabet, wherein the identified words includes at least one stressed syllable and/or at least one unstressed syllable defined in the preselected set, wherein each syllable includes one or more of the spelling characters, and
replacing/adjusting the identified word by adding a dot/square preceding each syllable, wherein the spelling characters of the syllable remain unchanged, and wherein the dot/square for the stressed syllable differs visually from the dot/square for the unstressed syllable.

4. The system of claim 1, wherein the method of encoding includes indicating silent characters, including by visually differentiating the silent characters from the spelling characters without changing shapes of the silent characters.

5. The system of claim 1, including one or more interactive teaching/practice computing systems that statically display on a screen or dynamically display in a video or other dynamic display system the encoded words, wherein the interactive computing systems are configured to automatically:
receive user inputs from a user of the interactive computing system;
classify the user into one of a plurality of categories based on the user inputs; and
select a phoneme set from a plurality of sets based on the user category using a predefined mapping between user categories and phoneme sets,
wherein the classifying includes:
the computing system generating measured values of the user's knowledge/performance; and
the computing system classifying the user into one of the plurality of categories based on the measured values, and
wherein the interactive computing system is configured to automatically:
present a test text in the base alphabet to the user by displaying the test text visibly or playing the test text audibly, wherein the test text includes: a plurality of words that can be selected by the user using the user interface (“user-selectable words”) including at least one test word and one or more distractor words which are not the test word; and
measure the values from user selections of the user-selectable words, including measuring how many of the least one test words are user selected, and/or how much time is taken to select the test words.

6. A method of converting/encoding a text document, the method including:
receiving data representing a source text that includes a plurality of human-readable characters in a base alphabet forming a plurality of words;
encoding the source text by:
for each word in the source text that has one or more characters (“spelling characters”) that are identified as having a sound other than a usual sound for that character, using a replacement word with respective compound characters that each include the spelling character and a sound character, wherein the sound characters:
are human-readable characters in the base alphabet and/or in one or more secondary alphabets,
are added to spelling characters to indicate that the spelling character makes the usual sound of the sound character,
are displayed so that spelling characters can be discriminated from sound characters, and
are added to the spelling characters such that the spelling characters and the sound characters remain human-readable such that the spelling character and the sound character of each compound character are within one visual field; and
outputting the encoded text in a human-readable form/format such that the encoded text includes the plurality of words from the source text with the compound characters visually indicating which of the spelling characters have a sound other than a usual sound for that character, and such that the spelling characters in the words in the encoded text are same and in the same order as the characters in the respective words in the source text.

7. The method of claim 6, wherein the sound characters are in a preselected phoneme set that includes:
a plurality of sound characters in a secondary alphabet associated with phonemes in the base alphabet that can be defined/pronounced using characters in the secondary alphabet;
a plurality of sound characters in the base alphabet associated with phonemes in the base alphabet that do not exist in the secondary alphabet; and/or
a plurality of sound characters in the base alphabet associated with phonemes in the International Phonetic Alphabet (IPA) that do not exist in the secondary alphabet.

8. The method of claim 6, wherein the adding of the one or more sound characters includes adding a gap/space between the sound characters and the respective spelling characters such that, in the words in the encoded text, the spelling characters are not touching the sound characters or if the sound characters do touch the spelling characters, less than 5% of the line length of the sound character touches the spelling character.

9. The method of claim 6, wherein one or more of any lowercase sound characters are shaped differently from the corresponding uppercase characters, including having a different font and/or positioned differently relative to the spelling character.

10. The method of claim 6, wherein the sound characters have a font size (“sound font size”) based on a font size (“source font size”) of the source text in a ratio of 6:9 and/or wherein the sound characters have a font size of at least 6 point.

11. The method of claim 6, including automatically generating a database of words for encoding the source text word by word.

12. The method of claim 11, including providing a user interface for a user to manually select marked-up phonetic words for words in the base alphabet.

13. The method of claim 11, including:
the computing system receiving user inputs from a user of an interactive computing system and/or from user input at registration;
the computing system classifying the user into one of a plurality of user categories based on the user inputs; and
the computing system selecting an optimal phoneme set whose characters are comprised by spelling and sound characters from the plurality of phoneme sets based on the user category using a predefined mapping between user categories and phoneme sets.

14. The method of claim 6, including showing stress in the replacement word with: a closed dot preceding a stressed syllable, and an open dot preceding an unstressed syllable; a dot preceding a stressed syllable, and a square preceding an unstressed syllable; an open dot preceding a stressed syllable, and a closed dot preceding an unstressed syllable; or a square preceding a stressed syllable, and a dot preceding an unstressed syllable.
